(19) United States
(12) Patent Application Publication
(10) Pub. No.: US 2004/0142847 A1
(43) Pub. Date: Jul. 22, 2004

(54) Detergent tablets with polyurethane coating

(76) Inventors: Rolf Bayersdoerfer, Duesseldorf (DE); Henriette Weber, Duesseldorf (DE); Frank Meier, Duesseldorf (DE)

Correspondence Address: Henkel Corporation, Law Department, Suite 200, 2500 Renaissance Blvd., Gulph Mills, PA, 19406, US

(21) Appl. No.: 10/301,353

(22) Filed: Nov. 21, 2002

(51) Int. Cl. C11D 17/00

(52) U.S. Cl. 510/445; 510/505

(57) ABSTRACT

Coated detergent tablets in which the coating not only protects the tablets against mechanical loads but is also rapidly disintegrable and/or soluble even without the addition of disintegration aids are provided with a coating which comprises polyurethanes formed from diisocyanates (I) and diols (II)

O═C═N—R¹—N═C═O (I),

H—O—R²—O—H (II),

the diols being selected at least fractionally from polyethylene glycols (II a) and/or polypropylene glycols (II b)

H—(O—CH₂—CH₂)ₙ—OH (II a),

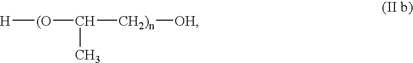

and R¹ and R² independently of one another standing for a substituted or unsubstituted, straight-chain or branched alkyl, aryl or alkylaryl radical having 1 to 24 carbon atoms, and n in each case standing for numbers from 5 to 2000.

The present invention is situated within the field of compact tablets having detersive properties. Laundry detergent and cleaning product tablets of this kind include, for example, tablets for the washing of textiles, machine dishwashing detergent tablets or hard surface cleaning product tablets, bleach tablets for use in washing machines or dishwashers, water softener tablets, and scouring salt tablets. The invention relates in particular to laundry detergent and cleaning product tablets which are used for washing textiles in a domestic washing machine and are referred to for short as laundry detergent tablets, and to detergent tablets for machine dishwashing.

Detergent tablets have been widely described in the prior art and are enjoying increasing popularity among users owing to the ease of dosing. Tableted detergents have a number of advantages over their powder-form counterparts: they are easier to dose and to handle, and have storage and transport advantages owing to their compact structure. Consequently, laundry detergent and cleaning product tablets have been described comprehensively in the patent literature as well. One problem which occurs again and again in connection with the use of detersive tablets is the inadequate disintegration and dissolution rate of the tablets under application conditions. Since tablets of sufficient stability, i.e., dimensional stability and fracture resistance, can be produced only by means of relatively high compressive pressures, there is severe compaction of the tablet constituents and, consequently, retarded disintegration of the tablet in the aqueous liquor, leading to excessively slow release of the active substances in the washing or cleaning operation. The retarded disintegration of the tablets also has the drawback that customary detergent tablets cannot be rinsed in via the rinse-in compartment of domestic washing machines, since the tablets do not break down with sufficient rapidity into secondary particles small enough to be rinsed from the rinse-in compartment into the wash drum. Another problem which occurs in particular with laundry detergent and cleaning product tablets is the friability of the tablets, or their often inadequate stability to abrasion. Thus, although it is possible to produce sufficiently fracture-stable, i.e., hard, laundry detergent and cleaning product tablets, these tablets are often not up to the loads involved in packaging, transit, and handling, i.e., dropping stresses and frictional stresses, with the result that edge-fracture and abrasion phenomena may impair the appearance of the tablet or may even lead to complete destruction of the tablet structure.

To overcome the dichotomy between hardness, i.e., transport and handling stability, and the ready disintegration of the tablets, numerous approaches to solutions have been developed in the prior art. One approach, which is known in particular from the field of pharmacy and has expanded into the field of laundry detergent and cleaning product tablets, is the incorporation of certain disintegration aids, which facilitate the ingress of water or which, on ingress of water, swell, evolve gas, or exert a disintegrating effect in another form. Other proposed solutions from the patent literature describe the compression of premixes of defined particle sizes, the separation of certain ingredients from certain other ingredients, and the coating of individual ingredients, or of the whole tablet, with binders.

The coating of laundry detergent and cleaning product tablets is subject matter of a number of patent applications.

For instance, European patent applications EP 846 754, EP 846 755, and EP 846 756 (Procter & Gamble) describe coated laundry detergent tablets comprising a “core” comprising compacted particulate laundry detergent and cleaning product, and a “coating”, the coating materials used comprising dicarboxylic acids, especially adipic acid, which if desired comprise further ingredients, examples being disintegration aids.

Coated laundry detergent tablets are also subject matter of European patent application EP 716 144 (Unilever). According to the details in that document, the hardness of the tablets may be intensified by means of a “coating” without detracting from the disintegration and dissolution times. Coating agents specified are film-forming substances, especially copolymers of acrylic acid and maleic acid, or sugars, and also polyethylene glycols.

The proposed solutions disclosed in the prior art utilize coating materials some of which are only retardedly soluble in the subsequent washing operation and some of which are not disintegrable at all until made so by the addition of disintegration aids. Accordingly, either there is an insufficient amount of active substance, if any, available in the liquor at the start of the cleaning operation, or the detergent cannot be metered via rinse-in compartments of household washing machines without additional costs being incurred.

The object on which the present invention was based, then, was to provide coated detergent tablets with which the advantageous properties of the high hardnesses are achieved without detriment to the short disintegration times, using small amounts of coating agents, the intention being that the coating materials provided should be substances which not only protect the tablets mechanically but are also readily soluble and/or disintegrable without the addition of further auxiliaries. The resistance of the tablets to dropping loads and frictional loads ought to match or exceed that of known tablets. Ideally it ought to be possible to supply the coated tablets to the market with minimized levels of packaging, i.e., with inexpensive individual packaging or even entirely without individual packaging without detriment to the storage stability of the tablets. Providing a process for producing such coated tablets which is easy to carry out and universally applicable was a further object of the present invention.

It has now been found that certain polyurethanes whose diol component is composed at least fractionally of polyethylene glycols or polypropylene glycols are also suitable for coating detergent tablets, and imbue them with advantageous properties.

The present invention provides tablets of compacted particulate detergent, comprising builder(s) and, if desired, further detergent ingredients, the tablets being provided with a coating which comprises polyurethanes formed from diisocyanates (I) and diols (II)

O═C═N—R¹—N═C═O (I),

H—O—R²—O—H (II),

The diols being selected at least fractionally from polyethylene glycols (II a) and/or polypropylene glycols (II b)

H—(O—CH₂—CH₂)ₙ—OH (II a),

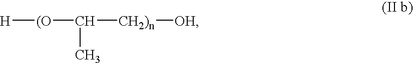

and R¹ and R² independently of one another stand for a substituted or unsubstituted, straight-chain or branched alkyl, aryl or alkylaryl radical having 1 to 24 carbon atoms and n stands in each case for numbers from 5 to 2000.

The detergent tablets of the invention are provided with a coating comprising certain polyurethanes. These polymers are described in more detail below.

Polyurethanes are polyadducts of at least two different types of monomer:

a di- or polyisocyanate (A) and

a compound (B) having at least 2 active hydrogen atoms per molecule.

The polyurethanes present in the coating of the tablets of the invention are obtained from reaction mixtures which include at least one diisocyanate of the formula (I) and at least one polyethylene glycol of the formula (II a) and/or at least one polypropylene glycol of the formula (II b).

In addition the reaction mixtures may comprise further polyisocyanates. Also possible is the presence in the reaction mixtures—and hence in the polyurethanes—of other diols, triols, diamines, triamines, polyetherols, and polyesterols. The compounds having more than 2 active hydrogen atoms are normally used only in small amounts in combination with a large excess of compounds having two active hydrogen atoms.

Where further diols, etc., are added it is necessary to observe certain proportions in relation to the polyethylene and/or polypropylene glycol units that are necessarily present in the polyurethane in accordance with the invention. Preference is given here to detergent tablets wherein at least 10% by weight, preferably at least 25% by weight, more preferably at least 50% by weight, and in particular at least 75% by weight of the diols incorporated into the polyurethane by reaction are selected from polyethylene glycols (II a) and/or polypropylene glycols (II b).

Besides the specific polyurethanes, the coating may comprise further ingredients such as other coating materials or ingredients of detergents, particularly dyes and/or fragrances or disintegration aids. In accordance with the invention, however, preference is given to detergent tablets wherein the coating contains at least 10% by weight, preferably at least 25% by weight, more preferably at least 50% by weight, and in particular at least 75% by weight of polyurethanes, particular preference being given to detergent tablets of the invention wherein the coating consists entirely of polyurethane.

The polyurethanes used as coating material in accordance with the invention comprise, as a monomer unit, diisocyanates of the formula (I). Diisocyanates used are predominantly hexamethylene diisocyanate, 2,4- and 2,6-toluene diisocyanate, 4,4′-methylenedi(phenylisocyanate), and, in particular, isophorone diisocyanate. These compounds can be described by the above formula I in which R¹ stands for a linking group of carbon atoms: for example, a methylene, ethylene, propylene, butylene, pentylene, hexylene, etc., group. In the aforementioned hexamethylene diisocyanate (HMDI), the most commonly used industrially, R¹=(CH₂)₆; in 2,4- or 2,6-toluene diisocyanate (TDI) R¹ stands for C₆H₃—CH₃), in 4,4′-methylenedi(phenyl isocyanate) (MDI) for C₆H₄—CH₂—C₆H₄), and in isophorone diisocyanate R¹ stands for the isophorone radical (3,5,5-trimethyl-2-cyclohexenone).

The polyurethanes used as coating material in accordance with the invention further include, as a monomer unit, diols of the formula (II), these diols originating at least fractionally from the group consisting of the polyethylene glycols (II a) and/or the polypropylene glycols (II b). Polyethylene glycols are polymers of ethylene glycol which satisfy the general formula (II a)

H—(O—CH₂—CH₂)ₙ—OH (II a)

in which n may adopt values between 5 and 2000. For polyethylene glycols there exist various nomenclatures, which can lead to confusion. It is common in the art to state the average relative molar weight after the letters “PEG”, so that “PEG 200” characterizes a polyethylene glycol having a relative molar mass of about 190 to about 210. For cosmetic ingredients a different nomenclature is used, in which the abbreviation PEG is provided with a hyphen and the hyphen is followed directly by a number which corresponds to the number n in the formula (II a) given above. According to this nomenclature (known as the INCI nomenclature, CTFA International Cosmetic Ingredient Dictionary and Handbook, 5th Edition, The Cosmetic, Toiletry and Fragrance Association, Washington, 1997), for example, PEG-6, PEG-8, PEG-9, PEG-10, PEG-12, PEG-14, and PEG-16 can be used as monomer units. Polyethylene glycols are available commercially, for example, under the trade names Carbowax PEG (Union Carbide), Emkapol® (ICI Americas), Lipoxol® MED (HÜLS America), Polyglycol® E (Dow Chemical), Alkapol® PEG (Rhone-Poulenc), and Lutrol® E (BASF).

Polypropylene glycols (abbreviation PPGs) are polymers of propylene glycol which satisfy the general formula (II b)

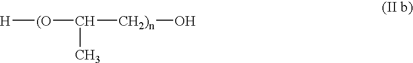

in which n may adopt values between 5 and 2000.

In the case both of compounds of the formula (II a) and of compounds of the formula (II b) preferred monomer units are those representatives wherein the number n stands for a number between 6 and 1500, preferably between 7 and 1200, more preferably between 8 and 1000, more preferably still between 9 and 500, and in particular between 10 and 200. For certain applications preference may be given to polyethylene and polypropylene glycols of the formula (II a) and/or (II b) in which n stands for a number of between 15 and 150, preferably between 20 and 100, more preferably between 25 and 75, and in particular between 30 and 60.

Examples of compounds which may also be present optionally in the reaction mixtures for preparing the polyurethanes are ethylene glycol, 1,2- and 1,3-propylene glycol, butylene glycols, ethylene diamine, propylene diamine, 1,4-diaminobutane, hexamethylene diamine, and α,\overline{ω}-diamines based on long-chain alkanes or polyalkylene oxides. Detergent tablets of the invention wherein the polyurethanes in the coating comprise additional diamines, preferably hexamethylene diamine, and/or hydroxycarboxylic acids, preferably dimethylolpropionic acid, are preferred.

To summarize these remarks, detergent tablets which are particularly preferred in the context of the present invention are those wherein the coating comprises polyurethanes formed from diisocyanates (I) and diols (II)

O═C═N—R¹—N═C═O (I),

H—O—R²—O—H (II),

where R¹ stands for a methylene, ethylene, propylene, butylene or pentylene group or for —(CH₂)₆— or for 2,4- or 2,6-C₆H₃—CH₃, or for C₆H₄—CH₂—C₆H₄ or for an isophorone radical (3,5,5-trimethyl-2-cyclohexenone) and R² is selected from —CH₂—CH₂—(O—CH₂—CH₂)ₙ— or —CH₂—CH₂—(O—CH(CH₃)—CH₂)ₙ— with n=4 to 1999.

Depending on the reactants which are reacted with one another to form the polyurethanes the polymers obtained have different structural units. Preference is given here to detergent tablets of the invention wherein the polyurethanes in the coating contain structural units of the formula (III)

—[O—C(O)—NH—R¹—NH—C(O)—O—R²]ₖ— (III),

in which R¹ stands for —(CH₂)₆— or for 2,4- or 2,6-C₆H₃—CH₃, or for C₆H₄—CH₂—C₆H₄, and R² is selected from —CH₂—CH₂—(O—CH₂—CH₂)ₙ— or —CH(CH₃)—CH₂—(O—CH(CH₃) —CH₂)ₙ—, where n is a number from 5 to 199 and k is a number from 1 to 2000.

In this context it is possible for the diisocyanates described as being preferred to be reacted with all of the diols described as being preferred, to give polyurethanes; consequently, preferred detergent tablets of the invention have a polyurethane coating which possess one or more of the structural units (III a) to (III h):

—[O—C(O)—NH—(CH₂)₆—NH—C(O)—O—CH₂—CH₂—(O—CH₂—CH₂)ₙ]ₖ— (III a),

—[0—C(O)—NH—(2,4-C₆H₃—CH₃)—NH—C(O)—O—CH₂—CH₂—(O—CH₂—CH₂)ₙ]ₖ— (III b),

—[O—C(O)—NH—(2,6-C₆H₃—CH₃)—NH—C(O)—O—CH₂—CH₂—(O—CH₂—CH₂)ₙ]ₖ— (III c),

—[O—C(O)—NH—(C₆H₄—CH₂—C₈H₄)—NH—C(O)—O—CH₂—CH₂—(O—CH₂—CH₂)ₙ]ₖ— (III d),

—[O—C(O)—NH—(2,6-CH₂)₆—NH—C(O)—O—CH(CH₃)—CH₂—(O—CH(CH₃)—(CH₂)ₙ]ₖ— (III e),

—[O—C(O)—NH—(2,4-C₈H₃—CH₃)—NH—C(O)—O—CH(CH₃)—CH₂—(O—CH(CH₃)—CH₂)ₙ]ₖ— (III f),

—[O—C(O)—NH—(2,6-C₈H₃—CH₃)—NH—C(O)—O—CH(CH₃)—CH₂—(O—CH(CH₃)—CH₂)ₙ]ₖ— (III g),

—[O—C(O)—NH—(C₈H₄—CH₂—C₆H₄)—NH—C(O)—O—CH(CH₃)—CH₂—(O —CH(CH₃)—CH₂)ₙ]ₖ— (III h),

where n is a number from 5 to 199 and k is a number from 1 to 2000.

As already mentioned above, besides diisocyanates (I) and diols (II), the reaction mixtures may also include further compounds from the group of the polyisocyanates (especially triisocyanates and tetraisocyanates) and also from the group of polyols and/or di- and/or polymaines. In particular, triols, tetrols, pentols, and hexols, and diamines and triamines, may be present in the reaction mixtures. The presence of compounds having more than two “active” hydrogen atoms (all aforementioned classes of substance except for the diamines) leads to partial crosslinking of the polyurethane reaction products and may give rise to advantageous properties such as, for example, control of dissolution behavior, abrasion stability or flexibility in the coating, process advantages when applying the coating, etc. The amount of such compounds having more than two “active” hydrogen atoms in the reaction mixture is normally less than 20% by weight of the reactants employed overall for the diisocyanates, preferably less than 15% by weight, and in particular less than 5% by weight.

Besides the polyurethanes, the coating may comprise further coating materials such as, for example, other polymers or else ingredients of detergents, such as dyes, fragrances, etc., this being preferred only in certain cases (see above).

In preferred embodiments of the present invention the polyurethanes in the coating possess molar masses of from 5000 to 150,000 g mol⁻¹, preferably from 10,000 to 100,000 g mol⁻¹, and in particular from 20,000 to 50,000 g mol⁻¹. Conforming detergent tablets are preferred in accordance with the invention.

Even with small amounts of coating material, the detergent tablets coated in accordance with the invention have markedly improved properties. It is preferred in the context of the present invention for the amount of coating material to constitute less than 5% by weight, preferably less than 2.5% by weight, and in particular less than 1% by weight of the total weight of the coated tablet. Detergent tablets wherein the weight ratio of uncoated tablet to coating is greater than 10:1, preferably greater than 25:1, and in particular greater than 50:1, therefore, are preferred embodiments of the present invention.

As a result of the small amounts in which the abovementioned polymers already bring about a highly load-bearing and advantageous coating of the detergent tablets compressed beforehand it is possible to realize coating thicknesses which are small in comparison to the dimensions of the tablets. In preferred detergent tablets the thickness of the coating on the tablet is from 0.1 to 500 μm, preferably from 0.5 to 250 μm, and in particular from 5 to 100 μm.

Besides the polyurethanes, the coated tablets of the invention may also comprise further ingredients in the coating, with further ingredients of detergents having proven particularly appropriate. These substances are described at length later on below generally, preferred detergents of the invention are those wherein the coating further comprises one or more substances selected from the groups consisting of disintegration aids, dyes, optical brighteners, fragrances, enzymes, bleaches, bleach activators, silver protectants, complexing agents, surfactants, graying inhibitors, and mixtures thereof in amounts of from 0.5 to 30% by weight, preferably from 1 to 20% by weight, and in particular from 2.5 to 10% by weight, based in each case on the weight of the coating.

It is possible with particular advantage in accordance with the invention to incorporate readily soluble substances, known as solubilizers, into the coatings. Particularly preferred solubilizers have solubilities of more than 200 grams of solubilizer in one liter of deionized water at 20° C. Suitable such preferred solubilizers for incorporation into the coating include, in the context of the present invention, a wide range of compounds, which may originate either from the group of the covalent compounds or from the group of the salts. It is preferred here for the solubilizers to have even higher solubilities, and so preferred solubilizers as an addition to the coating are those which have a solubility of more than 250 g per liter of water at 20° C., preferably of more than 300 g per liter of water at 20° C., and in particular of more than 350 g per liter of water at 20° C. An overview of the solubilities of solubilizers which are suitable in the context of the present invention is given by the listing below. The solubility figures reported in this table relate—unless other temperatures are specified explicitly—to the solubility at 20° C.

| | | |
|---|---|---|
| Sodium carbonate monohydrate | 210 | g/l |
| Sodium carbonate decahydrate | 210 | g/l |
| Lactose monohydrate (25° C.) | 216 | g/l |
| Disodium hydrogen phosphate dodecahydrate | 218 | g/l |
| Potassium dihydrogen phosphate | 222 | g/l |
| Potassium hydrogen carbonate | 224 | g/l |
| Sodium dithionite | 224 | g/l |
| Disodium fumarate (25° C.) | 228 | g/l |
| Calcium levulinate | 250 | g/l |
| Glycine (25° C.) | 250 | g/l |
| Potassium monopersulfate | 256 | g/l |
| Trisodium phosphate dodecahydrate | 258 | g/l |
| Ammonium iron(II) sulfate hexahydrate | 269 | g/l |
| Magnesium sulfate | 269 | g/l |
| Potassium hexacyanoferrate(II) trihydrate | 270 | g/l |
| (12° C.) | | |
| Disodium tartrate dihydrate | 290 | g/l |
| Calcium acetate hydrate | 300 | g/l |
| Potassium hexacyanoferrate(III) | 315 | g/l |
| Potassium nitrate | 320 | g/l |
| Manganese(II) acetate tetrahydrate | 330 | g/l |
| L(+)-ascorbic acid | 333 | g/l |
| Potassium chloride | 340 | g/l |
| Lithium sulfate monohydrate | 340 | g/l |
| Zinc sulfate monohydrate | 350 | g/l |
| Dipotassium oxalate monohydrate | 360 | g/l |
| Sodium chloride | 360 | g/l |
| L(−)-malic acid | 363 | g/l |
| Sodium bromate | 364 | g/l |
| Ammonium chloride | 370 | g/l |
| Ammonium dihydrogen phosphate | 370 | g/l |
| Iron(II) sulfate heptahydrate | 400 | g/l |
| Sodium azide (17° C.) | 417 | g/l |
| L-Lysine monohydrochloride | 420 | g/l |
| Magnesium nitrate hexahydrate | 420 | g/l |
| Zinc acetate dihydrate | 430 | g/l |
| Potassium hydrogen sulfate | 490 | g/l |
| Sodium acetate | 490 | g/l |
| Sodium sulfite (40° C.) | 495 | g/l |
| Magnesium perchlorate hydrate (25° C.) | 500 | g/l |
| Lithium nitrate | 522 | g/l |
| β-Alanine (25° C.) | 545 | g/l |
| L(−)-sorbose (17° C.) | 550 | g/l |
| Sodium peroxodisulfate | 556 | g/l |
| Sodium thiocyanate | 570 | g/l |
| Ammonium peroxodisulfate | 582 | g/l |
| Sodium glutamate (25° C.) | 590 | g/l |
| Ammonium bromide | 598 | g/l |
| Aluminum sulfate 18-hydrate | 600 | g/l |
| Aluminum sulfate hydrate (16-18 H₂O) | 600 | g/l |
| Potassium sodium tartrate tetrahydrate | 630 | g/l |
| Potassium bromide | 650 | g/l |
| Sodium hydrogen sulfate monohydrate | 670 | g/l |
| D(+)-Galactose (25° C.) | 680 | g/l |
| Sodium thiosulfate pentahydrate | 680 | g/l |
| Diammonium hydrogen phosphate | 690 | g/l |
| Magnesium sulfate heptahydrate | 710 | g/l |
| Calcium chloride | 740 | g/l |
| Trilithium citrate tetrahydrate (25° C.) | 745 | g/l |
| Ammonium sulfate | 760 | g/l |
| Manganese(II) sulfate monohydrate | 762 | g/l |
| Maleic acid (25° C.) | 788 | g/l |
| Ammonium carbamate | 790 | g/l |
| Sodium bromide | 790 | g/l |
| D(+)-Glucose monohydrate (25° C.) | 820 | g/l |
| Lithium chloride | 820 | g/l |
| Sodium formate | 820 | g/l |
| Sodium saccharin hydrate | 830 | g/l |
| Sodium nitrate | 880 | g/l |
| Tripotassium phosphate heptahydrate | 900 | g/l |
| Sodium sulfate decahydrate | 900 | g/l |
| Iron(III) chloride | 920 | g/l |
| Iron(III) chloride hexahydrate | 920 | g/l |
| Trisodium citrate 5.5-hydrate (25° C.) | 920 | g/l |
| Zinc sulfate heptahydrate | 960 | g/l |
| Ammonium carbonate | 1000 | g/l |
| Calcium chloride dihydrate | 1000 | g/l |
| Sodium chlorate | 1000 | g/l |
| Sodium polyphosphate | 1000 | g/l |
| Sodium salicylate | 1000 | g/l |
| Resorcinol | 1000 | g/l |
| Urea | 1080 | g/l |
| Sodium hydroxide | 1090 | g/l |
| Sodium dihydrogen phosphate monohydrate | 1103 | g/l |
| Potassium hydroxide | 1120 | g/l |
| Ammonium nitrate | 1183 | g/l |
| Sodium acetate trihydrate | 1190 | g/l |
| Ammonium iron(III) citrate | 1200 | g/l |
| Manganese(II) chloride dihydrate | 1200 | g/l |
| Ammonium iron(III) sulfate dodecahydrate | 1240 | g/l |
| (25° C.) | | |
| Potassium iodide | 1270 | g/l |
| Malonic acid | 1390 | g/l |
| Manganese(II) chloride | 1400 | g/l |
| DL-Malic acid (26° C.) | 1440 | g/l |
| Ammonium acetate | 1480 | g/l |
| Iron(II) chloride tetrahydrate (10° C.) | 1600 | g/l |
| Dipotassium hydrogen phosphate | 1600 | g/l |
| Citric acid monohydrate | 1630 | g/l |
| Ammonium thiocyanate (19° C.) | 1650 | g/l |
| Tripotassium citrate monohydrate (25° C.) | 1670 | g/l |
| Magnesium chloride hexahydrate | 1670 | g/l |
| Ammonium iodide | 1700 | g/l |
| Cesium sulfate | 1790 | g/l |
| Sodium iodide | 1790 | g/l |
| Cesium chloride | 1800 | g/l |
| Zinc nitrate hexahydrate | 1800 | g/l |
| Zinc nitrate tetrahydrate | 1800 | g/l |
| Ammonium amidosulfonate | 1950 | g/l |
| Sucrose (15° C.) | 1970 | g/l |
| Manganese(II) chloride tetrahydrate | 1980 | g/l |
| Dipotassium tartrate hemihydrate | 2000 | g/l |
| Sodium perchlorate monohydrate (15° C.) | 2090 | g/l |
| Potassium thiocyanate | 2170 | g/l |
| D(+)-Mannose (17° C.) | 2480 | g/l |
| Melibiose monohydrate (25° C.) | 2500 | g/l |
| Potassium acetate | 2530 | g/l |
| Cesium carbonate | 2615 | g/l |
| Zinc chloride | 3680 | g/l |
| D(−)-Fructose | 3750 | g/l |
| Manganese(II) nitrate tetrahydrate | 3800 | g/l |
| Zinc iodide | 4500 | g/l |
| Calcium choride hexahydrate | 5360 | g/l |

The amounts in which the stated substances can be incorporated into the coating of the invention are situated advantageously within the abovementioned range, i.e., at amounts of from 0.5 to 30% by weight, preferably from 1 to 20% by weight, and in particular from 2.5 to 10% by weight, based in each case on the weight of the coating.

Solubilizers which are preferred in the context of the present invention are the following substances:

| | | |
|---|---|---|
| Lactose monohydrate (25° C.) | 216 | g/l |
| Sodium dithionite | 224 | g/l |
| Disodium fumarate (25° C.) | 228 | g/l |
| Calcium levulinate | 250 | g/l |
| Glycine (25° C.) | 250 | g/l |
| Potassium monopersulfate | 256 | g/l |
| Ammonium iron(II) sulfate hexahydrate | 269 | g/l |
| Magnesium sulfate | 269 | g/l |
| Potassium hexacyanoferrate(II) trihydrate | 270 | g/l |
| (12° C.) | | |
| Disodium tartrate dihydrate | 290 | g/l |
| Calcium acetate hydrate | 300 | g/l |
| Potassium hexacyanoferrate(III) | 315 | g/l |
| Potassium nitrate | 320 | g/l |
| Manganese(II) acetate tetrahydrate | 330 | g/l |
| L(+)-ascorbic acid | 333 | g/l |
| Potassium chloride | 340 | g/l |
| Lithium sulfate monohydrate | 340 | g/l |
| Zinc sulfate monohydrate | 350 | g/l |
| Dipotassium oxalate monohydrate | 360 | g/l |
| Sodium chloride | 360 | g/l |
| L(−)-malic acid | 363 | g/l |
| Sodium bromate | 364 | g/l |
| Ammonium chloride | 370 | g/l |
| Ammonium dihydrogen phosphate | 370 | g/l |
| Iron(II) sulfate heptahydrate | 400 | g/l |
| Sodium azide (17° C.) | 417 | g/l |
| L-Lysine monohydrochloride | 420 | g/l |
| Magnesium nitrate hexahydrate | 420 | g/l |
| Zinc acetate dihydrate | 430 | g/l |
| Potassium hydrogen sulfate | 490 | g/l |
| Sodium acetate | 490 | g/l |
| Sodium sulfite (40° C.) | 495 | g/l |
| Magnesium perchlorate hydrate (25° C.) | 500 | g/l |
| Lithium nitrate | 522 | g/l |
| β-Alanine (25° C.) | 545 | g/l |
| L(−)-sorbose (17° C.) | 550 | g/l |
| Sodium peroxodisulfate | 556 | g/l |
| Sodium thiocyanate | 570 | g/l |
| Ammonium peroxodisulfate | 582 | g/l |
| Sodium glutamate (25° C.) | 590 | g/l |
| Ammonium bromide | 598 | g/l |
| Aluminum sulfate 18-hydrate | 600 | g/l |
| Aluminum sulfate hydrate (16-18 H₂O) | 600 | g/l |
| Potassium sodium tartrate tetrahydrate | 630 | g/l |
| Potassium bromide | 650 | g/l |
| Sodium hydrogen sulfate monohydrate | 670 | g/l |
| D(+)-Galactose (25° C.) | 680 | g/l |
| Sodium thiosulfate pentahydrate | 680 | g/l |
| Diammonium hydrogen phosphate | 690 | g/l |
| Magnesium sulfate heptahydrate | 710 | g/l |
| Calcium chloride | 740 | g/l |
| Trilithium citrate tetrahydrate (25° C.) | 745 | g/l |
| Ammonium sulfate | 760 | g/l |
| Manganese(II) sulfate monohydrate | 762 | g/l |
| Maleic acid (25° C.) | 788 | g/l |
| Ammonium carbamate | 790 | g/l |
| Sodium bromide | 790 | g/l |
| D(+)-Glucose monohydrate (25° C.) | 820 | g/l |
| Lithium chloride | 820 | g/l |
| Sodium formate | 820 | g/l |
| Sodium saccharin hydrate | 830 | g/l |
| Sodium nitrate | 880 | g/l |
| Iron(III) chloride | 920 | g/l |
| Iron(III) chloride hexahydrate | 920 | g/l |
| Zinc sulfate heptahydrate | 960 | g/l |
| Ammonium carbonate | 1000 | g/l |
| Calcium chloride dihydrate | 1000 | g/l |
| Sodium chlorate | 1000 | g/l |
| Sodium salicylate | 1000 | g/l |
| Resorcinol | 1000 | g/l |
| Urea | 1080 | g/l |
| Sodium hydroxide | 1090 | g/l |
| Potassium hydroxide | 1120 | g/l |
| Ammonium nitrate | 1183 | g/l |
| Sodium acetate trihydrate | 1190 | g/l |
| Ammonium iron(III) citrate | 1200 | g/l |
| Manganese(II) chloride dihydrate | 1200 | g/l |
| Ammonium iron(III) sulfate dodecahydrate | 1240 | g/l |
| (25° C.) | | |
| Potassium iodide | 1270 | g/l |
| Malonic acid | 1390 | g/l |
| Manganese(II) chloride | 1400 | g/l |
| DL-Malic acid (26° C.) | 1440 | g/l |
| Ammonium acetate | 1480 | g/l |
| Iron(II) chloride tetrahydrate (10° C.) | 1600 | g/l |
| Ammonium thiocyanate (19° C.) | 1650 | g/l |
| Magnesium chloride hexahydrate | 1670 | g/l |
| Ammonium iodide | 1700 | g/l |
| Cesium sulfate | 1790 | g/l |
| Sodium iodide | 1790 | g/l |
| Cesium chloride | 1800 | g/l |
| Zinc nitrate hexahydrate | 1800 | g/l |
| Zinc nitrate tetrahydrate | 1800 | g/l |
| Ammonium amidosulfonate | 1950 | g/l |
| Sucrose (15° C.) | 1970 | g/l |
| Manganese(II) chloride tetrahydrate | 1980 | g/l |
| Dipotassium tartrate hemihydrate | 2000 | g/l |
| Sodium perchlorate monohydrate (15° C.) | 2090 | g/l |
| Potassium thiocyanate | 2170 | g/l |
| D(+)-Mannose (17° C.) | 2480 | g/l |
| Melibiose monohydrate (25° C.) | 2500 | g/l |
| Potassium acetate | 2530 | g/l |
| Cesium carbonate | 2615 | g/l |
| Zinc chloride | 3680 | g/l |
| D(−)-Fructose | 3750 | g/l |
| Manganese(II) nitrate tetrahydrate | 3800 | g/l |
| Zinc iodide | 4500 | g/l |
| Calcium choride hexahydrate | 5360 | g/l |

Above, the constituents of the coating of the tablets of the invention have been described in detail. Below, the constituents of the tablets per se, i.e., of the uncoated tablets, are described. These tablets are sometimes referred to below as “base tablets” in order to establish a verbal delimitation from the term “tablet” for the coated laundry detergent and cleaning product tablets of the invention; in some cases, however, the general term “tablet” is used. Since the present invention provides base tablets provided with a coating, the statements made below for the base tablets do of course also apply to laundry detergent and cleaning product tablets of the invention which meet the corresponding conditions, and vice versa.

The base tablets comprise, as essential constituents, builder(s). The base tablets of the invention may comprise all of the builders commonly used in laundry detergents and cleaning products, i.e., in particular, zeolites, silicates, carbonates, organic cobuilders, and—where there are no ecological prejudices against their use—phosphates as well.

Suitable crystalline, layered sodium silicates possess the general formula NaMSiₓO₂ₓ₊₁·H₂O, where M is sodium or hydrogen, x is a number from 1.9 to 4, y is a number from 0 to 20, and preferred values for x are 2, 3 or 4. Preferred crystalline phyllosilicates of the formula indicated are those in which M is sodium and x adopts the value 2 or 3. In particular, both β- and δ-sodium disilicates Na₂Si₂O₅·yH₂O are preferred.

It is also possible to use amorphous sodium silicates having an Na₂O:SiO₂ modulus of from 1:2 to 1:3.3, preferably from 1:2 to 1:2.8, and in particular from 1:2 to 1:2.6, which are dissolution-retarded and have secondary washing properties. The retardation of dissolution relative to conventional amorphous sodium silicates may have been brought about in a variety of ways—for example, by surface treatment, compounding, compacting, or overdrying. In the context of this invention, the term “amorphous” also embraces “X-ray-amorphous”. This means that in X-ray diffraction experiments the silicates do not yield the sharp X-ray reflections typical of crystalline substances but instead yield at best one or more maxima of the scattered X-radiation, having a width of several degree units of the diffraction angle. However, good builder properties may result, even particularly good builder properties, if the silicate particles in electron diffraction experiments yield vague or even sharp diffraction maxima. The interpretation of this is that the products have microcrystalline regions with a size of from 10 to several hundred nm, values up to max. 50 nm and in particular up to max. 20 nm being preferred. So-called X-ray-amorphous silicates of this kind likewise possess retarded dissolution relative to the conventional waterglasses. Particular preference is given to compacted amorphous silicates, compounded amorphous silicates, and overdried X-ray-amorphous silicates.

The finely crystalline, synthetic zeolite used, containing bound water, is preferably zeolite A and/or P. A particularly preferred zeolite P is Zeolite MAP® (commercial product from Crosfield). Also suitable, however, are zeolite X and also mixtures of A, X and/or P. A product available commercially and able to be used with preference in the context of the present invention, for example, is a cocrystallizate of zeolite X and zeolite A (approximately 80% by weight zeolite X), which is sold by CONDEA Augusta S.p.A. under the brand name VEGOBOND AX® and may be described by the formula

nNa₂O·(1−n)K₂O·Al₂O₃·(2−2.5)SiO₂·(3.5−5.5)H₂O.

The zeolite may be used either as a builder in a granular compound or as a kind of “powdering” for the entire mixture intended for compression, it being common to utilize both methods for incorporating the zeolite into the premix. Suitable zeolites have an average particle size of less than 10 μn (volume distribution; measurement method: Coulter counter) and contain preferably from 18 to 22% by weight, in particular from 20 to 22% by weight, of bound water.

Of course, the widely known phosphates may also be used as builder substances provided such a use is not to be avoided on ecological grounds. Among the large number of commercially available phosphates, the alkali metal phosphates, with particular preference being given to pentasodium and pentapotassium triphosphate (sodium and potassium tripolyphosphate, respectively), possess the greatest importance in the laundry detergent and cleaning product industry.

Alkali metal phosphates is the collective term for the alkali metal (especially sodium and potassium) salts of the various phosphoric acids, among which metaphosphoric acids (HPO₃)n and orthophosphoric acid H₃PO₄, in addition to higher-molecular-mass representatives, may be distinguished. The phosphates combine a number of advantages: they act as alkali carriers, prevent limescale deposits on machine components, and lime incrustations on fabrics, and additionally contribute to cleaning performance.

Sodium dihydrogen phosphate, NaH₂PO₄, exists as the dihydrate (density 1.91 g cm⁻³, melting point 60°) and as the monohydrate (density 2.04 g cm⁻³). Both salts are white powders of very ready solubility in water which lose the water of crystallization on heating and undergo conversion at 200° C. into the weakly acidic diphosphate (disodium hydrogen diphosphate, Na₂H₂P₂O₇) and at the higher temperature into sodium trimetaphosphate (Na₃P₃O₉) and Maddrell's salt (see below). NaH₂PO₄ reacts acidically; it is formed if phosphoric acid is adjusted to a pH of 4.5 using sodium hydroxide solution and the slurry is sprayed. Potassium dihydrogen phosphate (primary or monobasic potassium phosphate, potassium biphosphate, PDP), KH₂PO₄, is a white salt with a density of 2.33 g cm⁻³, has a melting point of 253° [decomposition with formation of potassium polyphosphate (KPO₃)ₓ], and is readily soluble in water.

Disodium hydrogen phosphate (secondary sodium phosphate), Na₂HPO₄, is a colorless, crystalline salt which is very readily soluble in water. It exists in anhydrous form and with 2 mol (density 2.066 g cm⁻³, water loss at 95°), 7 mol (density 1.68 g cm⁻³, melting point 48° with loss of 5 H₂O), and 12 mol of water (density 1.52 g cm⁻³, melting point 35° with loss of 5 H₂O), becomes anhydrous at 100°, and if heated more severely undergoes transition to the diphosphate Na₄P₂O₇. Disodium hydrogen phosphate is prepared by neutralizing phosphoric acid with sodium carbonate solution using phenolphthalein as indicator. Dipotassium hydrogen phosphate (secondary or dibasic potassium phosphate), K₂HPO₄, is an amorphous white salt which is readily soluble in water.

Trisodium phosphate, tertiary sodium phosphate, Na₃PO₄, exists as colorless crystals which as the dodecahydrate have a density of 1.62 g cm⁻³ and a melting point of 73-76° C. (decomposition), as the decahydrate (corresponding to 19-20% P₂O₅) have a melting point of 100° C., and in anhydrous form (corresponding to 39-40% P₂O₅) have a density of 2.536 g cm⁻³. Trisodium phosphate is readily soluble in water, with an alkaline reaction, and is prepared by evaporative concentration of a solution of precisely 1 mol of disodium phosphate and 1 mol of NaOH. Tripotassium phosphate (tertiary or tribasic potassium phosphate), K₃PO₄, is a white, deliquescent, granular powder of density 2.56 g cm⁻³, has a melting point of 1340°, and is readily soluble in water with an alkaline reaction. It is produced, for example, when Thomas slag is heated with charcoal and potassium sulfate. Despite the relatively high price, the more readily soluble and therefore highly active potassium phosphates are frequently preferred in the cleaning products industry over the corresponding sodium compounds.

Tetrasodium diphosphate (sodium pyrophosphate), Na₄P₂O₇, exists in anhydrous form (density 2.534 g cm⁻³ melting point 988°, 880° also reported) and as the decahydrate (density 1.815-1.836 g cm⁻³, melting point 94° with loss of water). In the case of substances are colorless crystals which dissolve in water with an alkaline reaction. Na₄P₂O₇ is formed when disodium phosphate is heated at >200° or by reacting phosphoric acid with sodium carbonate in stoichiometric ratio and dewatering the solution by spraying. The decahydrate complexes heavy metal salts and water hardeners and therefore reduces the hardness of the water. Potassium diphosphate (potassium pyrophosphate), K₄P₂O₇, exists in the form of the trihydrate and is a colorless, hygroscopic powder of density 2.33 g cm⁻³ which is soluble in water, the pH of the 1% strength solution at 25° being 10.4.

Condensation of NaH₂PO₄ or of KH₂PO₄ gives rise to higher-molecular-mass sodium and potassium phosphates, among which it is possible to distinguish cyclic representatives, the sodium and potassium metaphosphates, and catenated types, the sodium and potassium polyphosphates. For the latter in particular a large number of names are in use: fused or calcined phosphates, Graham's salt, Kurrol's and Maddrell's salt. All higher sodium and potassium phosphates are referred to collectively as condensed phosphates.

The industrially important pentasodium triphosphate, Na₅P₃O₁₀ (sodium tripolyphosphate), is a nonhygroscopic, white, water-soluble salt which is anhydrous or crystallizes with 6 H₂O and has the general formula NaO-[P(O)(ONa)-O]ₙ-Na where n=3. About 17 g of the anhydrous salt dissolve in 100 g of water at room temperature, at 60° about 20 g, at 100° around 32 g; after heating the solution at 100° C. for two hours, about 8% orthophosphate and 15% diphosphate are produced by hydrolysis. For the preparation of pentasodium triphosphate, phosphoric acid is reacted with sodium carbonate solution or sodium hydroxide solution in stoichiometric ratio and the solution is dewatered by spraying. In a similar way to Graham's salt and sodium diphosphate, pentasodium triphosphate dissolves numerous insoluble metal compounds (including lime soaps, etc). Pentapotassium triphosphate, K₅P₃O₁₀ (potassium tripolyphosphate), is commercialized, for example, in the form of a 50% strength by weight solution (>23% P₂O₅, 25% K₂O). The potassium polyphosphates find broad application in the laundry detergents and cleaning products industry. There also exist sodium potassium tripolyphosphates, which may likewise be used for the purposes of the present invention. These are formed, for example, when sodium trimetaphosphate is hydrolyzed with KOH:

(NaPO₃)₃+2 KOH→Na₃K₂P₃O₁₀+H₂O

They can be used in accordance with the invention in precisely the same way as sodium tripolyphospate, potassium tripolyphosphate, or mixtures of these two; mixtures of sodium tripolyphosphate and sodium potassium tripolyphosphate, or mixtures of potassium tripolyphosphate and sodium potassium tripolyphosphate, or mixtures of sodium tripolyphosphate and potassium tripolyphosphate and sodium potassium tripolyphospate, may also be used in accordance with the invention.

Organic cobuilders which may be used in the base tablets of the invention are, in particular, polycarboxylates/polycarboxylic acids, polymeric polycarboxylates, aspartic acid, polyacetals, dextrins, further organic cobuilders (see below), and phosphonates. These classes of substance are described below.

Organic builder substances which may be used are, for example, the polycarboxylic acids, usable in the form of their sodium salts, the term polycarboxylic acids meaning those carboxylic acids which carry more than one acid function. Examples of these are citric acid, adipic acid, succinic acid, glutaric acid, malic acid, tartaric acid, maleic acid, fumaric acid, sugar acids, amino carboxylic acids, nitrilotriacetic acid (NTA), provided such use is not objectionable on ecological grounds, and also mixtures thereof. Preferred salts are the salts of the polycarboxylic acids such as citric acid, adipic acid, succinic acid, glutaric acid, tartaric acid, sugar acids, and mixtures thereof.

The acids per se may also be used. In addition to their builder effect, the acids typically also possess the property of an acidifying component and thus also serve to establish a lower and milder pH of laundry detergents or cleaning products. In this context, mention may be made in particular of citric acid, succinic acid, glutaric acid, adipic acid, gluconic acid, and any desired mixtures thereof.

Also suitable as builders are polymeric polycarboxylates; these are, for example, the alkali metal salts of polyacrylic acid or of polymethacrylic acid, examples being those having a relative molecular mass of from 500 to 70,000 g/mol.

The molecular masses reported for polymeric polycarboxylates, for the purposes of this document, are weight-average molecular masses, M_{W}, of the respective acid form, determined basically by means of gel permeation chromatography (GPC) using a UV detector. The measurement was made against an external polyacrylic acid standard, which owing to its structural similarity to the polymers under investigation provides realistic molecular weight values. These figures differ markedly from the molecular weight values obtained using polystyrenesulfonic acids as the standard. The molecular masses measured against polystyrenesulfonic acids are generally much higher than the molecular masses reported in this document.

Suitable polymers are, in particular, polyacrylates, which preferably have a molecular mass of from 2000 to 20,000 g/mol. Owing to their superior solubility, preference in this group may be given in turn to the short-chain polyacrylates, which have molecular masses of from 2000 to 10,000 g/mol, and with particular preference from 3000 to 5000 g/mol.

Also suitable are copolymeric polycarboxylates, especially those of acrylic acid with methacrylic acid and of acrylic acid or methacrylic acid with maleic acid. Copolymers which have been found particularly suitable are those of acrylic acid with maleic acid which contain from 50 to 90% by weight acrylic acid and from 50 to 10% by weight maleic acid. Their relative molecular mass, based on free acids, is generally from 2000 to 70,000 g/mol, preferably from 20,000 to 50,000 g/mol, and in particular from 30,000 to 40,000 g/mol.

The (co)polymeric polycarboxylates can be used either as powders or as aqueous solutions. The (co)polymeric polycarboxylate content of the compositions is preferably from 0.5 to 20% by weight, in particular from 3 to 10% by weight.

In order to improve the solubility in water, the polymers may also contain allylsulfonic acids, such as allyloxybenzenesulfonic acid and methallylsulfonic acid, for example, as monomers.

Particular preference is also given to biodegradable polymers comprising more than two different monomer units, examples being those comprising, as monomers, salts of acrylic acid and of maleic acid, and also vinyl alcohol or vinyl alcohol derivatives, or those comprising, as monomers, salts of acrylic acid and of 2-alkylallylsulfonic acid, and also sugar derivatives.

Further preferred copolymers are those, whose monomers are preferably acrolein and acrylic acid/acrylic acid salts, and, respectively, acrolein and vinyl acetate.

Similarly, further preferred builder substances that may be mentioned include polymeric amino dicarboxylic acids, their salts or their precursor substances. Particular preference is given to polyaspartic acids and their salts and derivatives, which have not only cobuilder properties but also a bleach-stabilizing action.

Further suitable builder substances are polyacetals, which may be obtained by reacting dialdehydes with polyol carboxylic acids having 5 to 7 carbon atoms and at least 3 hydroxyl groups. Preferred polyacetals are obtained from dialdehydes such as glyoxal, glutaraldehyde, terephthalaldehyde and mixtures thereof and from polyol carboxylic acids such as gluconic acid and/or glucoheptonic acid.

Further suitable organic builder substances are dextrins, examples being oligomers and polymers of carbohydrates, which may be obtained by partial hydrolysis of starches. The hydrolysis can be conducted by customary processes; for example, acid-catalyzed or enzyme-catalyzed processes. The hydrolysis products preferably have average molecular masses in the range from 400 to 500,000 g/mol. Preference is given here to a polysaccharide having a dextrose equivalent (DE) in the range from 0.5 to 40, in particular from 2 to 30, DE being a common measure of the reducing effect of a polysaccharide in comparison to dextrose, which possesses a DE of 100. It is possible to use both maltodextrins having a DE of between 3 and 20 and dried glucose syrups having a DE of between 20 and 37, and also so-called yellow dextrins and white dextrins having higher molecular masses, in the range from 2000 to 30,000 g/mol.

The oxidized derivatives of such dextrins comprise their products of reaction with oxidizing agents which are able to oxidize at least one alcohol function of the saccharide ring to the carboxylic acid function. Likewise suitable is an oxidized oligosaccharide. A product oxidized at C₆ of the saccharide ring may be particularly advantageous.

Oxydisuccinates and other derivatives of disuccinates, preferably ethylenediamine disuccinate, are further suitable cobuilders. Ethylenediamine N,N′-disuccinate (EDDS) is used preferably in the form of its sodium or magnesium salts. Further preference in this context is given to glycerol disuccinates and glycerol trisuccinates as well. Suitable use amounts in formulations containing zeolite and/or silicate are from 3 to 15% by weight.

Examples of further useful organic cobuilders are acetylated hydroxy carboxylic acids and their salts, which may also be present in lactone form and which contain at least 4 carbon atoms, at least one hydroxyl group, and not more than two acid groups.

A further class of substance having cobuilder properties is represented by the phosphonates. The phosphonates in question are, in particular, hydroxyalkane- and aminoalkanephosphonates. Among the hydroxyalkanephosphonates, 1-hydroxyethane-1,1-diphosphonate (HEDP) is of particular importance as a cobuilder. It is used preferably as the sodium salt, the disodium salt being neutral and the tetrasodium salt giving an alkaline (pH 9) reaction. Suitable aminoalkanephosphonates are preferably ethylenediaminetetramethylenephosphonate (EDTMP), diethylenetriaminepentamethylenephosphonate (DTPMP), and their higher homologs. They are used preferably in the form of the neutrally reacting sodium salts, e.g., as the hexasodium salt of EDTMP or as the hepta- and octasodium salt of DTPMP. As a builder in this case, preference is given to using HEDP from the class of the phosphonates. Furthermore, the aminoalkanephosphonates possess a pronounced heavy metal binding capacity. Accordingly, and especially if the compositions also contain bleach, it may be preferred to use aminoalkanephosphonates, expecially DTPMP, or to use mixtures of said phosphonates.

Furthermore, all compounds capable of forming complexes with alkaline earth metal ions may be used as cobuilders.

The amount of builder is usually between 10 and 70% by weight, preferably between 15 and 60% by weight, and in particular between 20 and 50% by weight. In turn, the amount of builders used is dependent on the intended use, so that bleach tablets may contain higher amounts of builders (for example, between 20 and 70% by weight, preferably between 25 and 65% by weight, and in particular between 30 and 55% by weight) than, say, laundry detergent tablets (usually from 10 to 50% by weight, preferably from 12.5 to 45% by weight, and in particular between 17.5 and 37.5% by weight).

Preferred base tablets further comprise one or more surfactants. In the base tablets it is possible to use anionic, nonionic, cationic and/or amphoteric surfactants, and/or mixtures thereof. From a performance standpoint, preference is given to mixtures of anionic and nonionic surfactants. The total surfactant content of the tablets is from 5 to 60% by weight, based on the tablet weight, preference being given to surfactant contents of more than 15% by weight.

Anionic surfactants used are, for example, those of the sulfonate and sulfate type. Preferred surfactants of the sulfonate type are C₉-₁₃ alkylbenzenesulfonates, olefinsulfonates, i.e., mixtures of alkenesulfonates and hydroxyalkanesulfonates, and also disulfonates, as are obtained, for example, from C12-18 monoolefins having a terminal or internal double bond by sulfonating with gaseous sulfur trioxide followed by alkaline or acidic hydrolysis of the sulfonation products. Also suitable are alkanesulfonates, which are obtained from C₁₂-₁₈ alkanes, for example, by sulfochlorination or sulfoxidation with subsequent hydrolysis or neutralization, respectively. Likewise suitable, in addition, are the esters of α-sulfo fatty acids (ester sulfonates), e.g., the α-sulfonated methyl esters of hydrogenated coconut, palm kernel or tallow fatty acids.

Further suitable anionic surfactants are sulfated fatty acid glycerol esters. Fatty acid glycerol esters are the monoesters, diesters and triesters, and mixtures thereof, as obtained in the preparation by esterification of a monoglycerol with from 1 to 3 mol of fatty acid or in the transesterification of triglycerides with from 0.3 to 2 mol of glycerol. Preferred sulfated fatty acid glycerol esters are the sulfation products of saturated fatty acids having 6 to 22 carbon atoms, examples being those of caproic acid, caprylic acid, capric acid, myristic acid, lauric acid, palmitic acid, stearic acid, or behenic acid.

Preferred alk(en)yl sulfates are the alkali metal salts, and especially the sodium salts, of the sulfuric monoesters of C₁₂-C₁₈ fatty alcohols, examples being those of coconut fatty alcohol, tallow fatty alcohol, lauryl, myristyl, cetyl or stearyl alcohol, or of C₁₀-C₂₀ oxo alcohols, and those monoesters of secondary alcohols of these chain lengths. Preference is also given to alk(en)yl sulfates of said chain length which contain a synthetic straight-chain alkyl radical prepared on a petrochemical basis, these sulfates possessing degradation properties similar to those of the suitable compounds based on fatty-chemical raw materials. From a detergents standpoint, the C₁₂-C₁₆ alkyl sulfates and C₁₂-C₁₅ alkyl sulfates, and also C₁₄-C₁₅ alkyl sulfates, are preferred. In addition, 2,3-alkyl sulfates, which may for example be prepared in accordance with U.S. Pat. Nos. 3,234,258 or 5,075,041 and obtained as commercial products from Shell Oil Company under the name DAN®, are suitable anionic surfactants.

Also suitable are the sulfuric monoesters of the straight-chain or branched C₇₋₂₁ alcohols ethoxylated with from 1 to 6 mol of ethylene oxide, such as 2-methyl-branched C₉₋₁₁ alcohols containing on average 3.5 mol of ethylene oxide (EO) or C₁₂₋₁₈ fatty alcohols containing from 1 to 4 EO. Because of their high foaming behavior they are used in cleaning products only in relatively small amounts, for example, in amounts of from 1 to 5% by weight.

Further suitable anionic surfactants include the salts of alkylsulfosuccinic acid, which are also referred to as sulfosuccinates or as sulfosuccinic esters and which constitute monoesters and/or diesters of sulfosuccinic acid with alcohols, preferably fatty alcohols and especially ethoxylated fatty alcohols. Preferred sulfosuccinates comprise C₈₋₁₈ fatty alcohol radicals or mixtures thereof. Especially preferred sulfosuccinates contain a fatty alcohol radical derived from ethoxylated fatty alcohols which themselves represent nonionic surfactants (for description, see below). Particular preference is given in turn to sulfosuccinates whose fatty alcohol radicals are derived from ethoxylated fatty alcohols having a narrowed homolog distribution. Similarly, it is also possible to use alk(en)ylsuccinic acid containing preferably 8 to 18 carbon atoms in the alk(en)yl chain, or salts thereof.

Further suitable anionic surfactants are, in particular, soaps. Suitable soaps include saturated fatty acid soaps, such as the salts of lauric acid, myristic acid, palmitic acid, stearic acid, hydrogenated erucic acid and behenic acid, and, in particular, mixtures of soaps derived from natural fatty acids, e.g., coconut, palm kernel, or tallow fatty acids.

The anionic surfactants, including the soaps, may be present in the form of their sodium, potassium or ammonium salts and also as soluble salts of organic bases, such as mono-, di- or triethanolamine. Preferably, the anionic surfactants are in the form of their sodium or potassium salts, in particular in the form of the sodium salts.

Nonionic surfactants used are preferably alkoxylated, advantageously ethoxylated, especially primary, alcohols having preferably 8 to 18 carbon atoms and on average from 1 to 12 mol of ethylene oxide (EO) per mole of alcohol, in which the alcohol radical may be linear or, preferably, methyl-branched in position 2 and/or may comprise linear and methyl-branched radicals in a mixture, as are commonly present in oxo alcohol radicals. In particular, however, preference is given to alcohol ethoxylates containing linear radicals from alcohols of natural origin having 12 to 18 carbon atoms, e.g., from coconut, palm, tallow fatty or oleyl alcohol and on average from 2 to 8 EO per mole of alcohol. Preferred ethoxylated alcohols include, for example, C₁₂₋₁₄ alcohols containing 3 EO or 4 EO, C₉₋₁₁ alcohol containing 7 EO, C₁₃₋₁₅ alcohols containing 3 EO, 5 EO, 7 EO or 8 EO, C₁₂₋₁₈ alcohols containing 3 EO, 5 EO or 7 EO, and mixtures thereof, such as mixtures of C₁₂₋₁₄ alcohol containing 3 EO and C₁₂₋₁₈ alcohol containing 5 EO. The stated degrees of ethoxylation represent statistical mean values, which for a specific product may be an integer or a fraction. Preferred alcohol ethoxylates have a narrowed homolog distribution (narrow range ethoxylates, NRES) . In addition to these nonionic surfactants it is also possible to use fatty alcohols containing more than 12 EO. Examples thereof are tallow fatty alcohol containing 14 EO, 25 EO, 30 EO or 40 EO.

As further nonionic surfactants, furthermore, use may also be made of alkyl glycosides of the general formula RO(G)ₓ, where R is a primary straight-chain or methyl-branched aliphatic radical, especially an aliphatic radical methyl-branched in position 2, containing 8 to 22, preferably 12 to 18, carbon atoms, and G is the symbol representing a glycose unit having 5 or 6 carbon atoms, preferably glucose. The degree of oligomerization, x, which indicates the distribution of monoglycosides and oligoglycosides, is any desired number between 1 and 10; preferably, x is from 1.2 to 1.4.

A further class of nonionic surfactants used with preference, which are used either as sole nonionic surfactant or in combination with other nonionic surfactants, are alkoxylated, preferably ethoxylated, or ethoxylated and propoxylated, fatty acid alkyl esters, preferably having 1 to 4 carbon atoms in the alkyl chain, especially fatty acid methyl esters.

Nonionic surfactants of the amine oxide type, examples being N-cocoalkyl-N,N-dimethylamine oxide and N-tallowalkyl-N,N-dihydroxyethylamine oxide, and of the fatty acid alkanolamide type, may also be suitable. The amount of these nonionic surfactants is preferably not more than that of the ethoxylated fatty alcohols, in particular not more than half thereof.

Further suitable surfactants are polyhydroxy fatty acid amides of the formula (II),

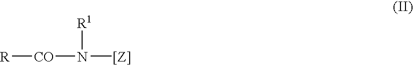

where RCO is an aliphatic acyl radical having 6 to 22 carbon atoms, R¹ is hydrogen or an alkyl or hydroxyalkyl radical having 1 to 4 carbon atoms, and [Z] is a linear or branched polyhydroxyalkyl radical having 3 to 10 carbon atoms and from 3 to 10 hydroxyl groups. The polyhydroxy fatty acid amides are known substances which are customarily obtainable by reductive amination of a reducing sugar with ammonia, an alkylamine or an alkanolamine, and subsequent acylation with a fatty acid, a fatty acid alkyl ester or a fatty acid chloride.

The group of the polyhydroxy fatty acid amides also includes compounds of the formula (III)

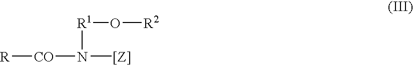

where R is a linear or branched alkyl or alkenyl radical having 7 to 12 carbon atoms, R¹ is a linear, branched or cyclic alkyl radical or an aryl radical having 2 to 8 carbon atoms and R² is a linear, branched or cyclic alkyl radical or an aryl radical or an oxyalkyl radical having 1 to 8 carbon atoms, preference being given to C₁₋₄ alkyl radicals or phenyl radicals, and [Z] is a linear polyhydroxyalkyl radical whose alkyl chain is substituted by at least two hydroxyl groups, or alkoxylated, preferably ethoxylated or propoxylated, derivatives of said radical.

[Z] is preferably obtained by reductive amination of a reduced sugar, e.g., glucose, fructose, maltose, lactose, galactose, mannose, or xylose. The N-alkoxy- or N-aryloxy-substituted compounds may then be converted to the desired polyhydroxy fatty acid amides by reaction with fatty acid methyl esters in the presence of an alkoxide as catalyst.

In the context of the present invention, preference is given to base tablets comprising anionic and nonionic surfactant(s); performance advantages may result from certain proportions in which the individual classes of surfactant are used.

For example, particular preference is given to base tablets in which the ratio of anionic surfactant(s) to nonionic surfactant(s) is between 10:1 and 1:10, preferably between 7.5:1 and 1:5, and in particular between 5:1 and 1:2. Preference is also given to laundry detergent and cleaning product tablets which comprise anionic and/or nonionic surfactant(s) and have total surfactant contents of more than 2.5% by weight, preferably more than 5% by weight, and in particular more than 10% by weight, based in each case on the tablet weight. Particularly preferred are laundry detergent and cleaning product tablets comprising surfactant(s), preferably anionic and/or nonionic surfactant(s), in amounts of from 5 to 40% by weight, preferably from 7.5 to 35% by weight, with particular preference from 10 to 30% by weight, and in particular from 12.5 to 25% by weight, based in each case on the tablet weight.

From a performance standpoint it may be advantageous if certain classes of surfactant are absent from some phases of the base tablets or from the tablet as a whole, i.e., from all phases. A further important embodiment of the present invention therefore envisages that at least one phase of the tablets is free from nonionic surfactants.

Conversely, however, the presence of certain surfactants in individual phases or in the whole tablet, i.e., in all phases, may produce a positive effect. The incorporation of the above-described alkyl polyglycosides has been found advantageous, and so preference is given to base tablets in which at least one phase of the tablets comprises alkyl polyglycosides.

Similarly to the case with the nonionic surfactants, the omission of anionic surfactants from certain phases or all phases may also result in base tablets better suited to certain fields of application. In the context of the present invention, therefore, it is also possible to conceive of laundry detergent and cleaning product tablets in which at least one phase of the tablets is free from anionic surfactants.

In order to facilitate the disintegration of highly compacted tablets, it is possible to incorporate disintegration aids, known as tablet disintegrants, into the tablets in order to reduce the disintegration times. Tablet disintegrants, or disintegration accelerators, are understood in accordance with Römpp (9th Edition, Vol. 6, p. 4440) and Voigt “Lehrbuch der pharmazeutischen Technologie” [Textbook of pharmaceutical technology] (6th Edition, 1987, pp. 182-184) to be auxiliaries which ensure the rapid disintegration of tablets in water or gastric fluid and the release of the drugs in absorbable form.

These substances increase in volume on ingress of water, with on the one hand an increase in the intrinsic volume (swelling) and on the other hand, by way of the release of gases, the generation of a pressure which causes the tablets to disintegrate into smaller particles. Examples of established disintegration aids are carbonate/citric acid systems, with the use of other organic acids also being possible. Examples of swelling disintegration aids are synthetic polymers such as polyvinylpyrrolidone (PVP) or natural polymers and/or modified natural substances such as cellulose and starch and their derivatives, alginates, or casein derivatives.

Preferred base tablets contain from 0.5 to 10% by weight, preferably from 3 to 7% by weight, and in particular from 4 to 6% by weight, of one or more disintegration aids, based in each case on the tablet weight.

Preferred disintegrants used in the context of the present invention are cellulose-based disintegrants and so preferred base tablets comprise a cellulose-based disintegrant of this kind in amounts from 0.5 to 10% by weight, preferably from 3 to 7% by weight, and in particular from 4 to 6% by weight. Pure cellulose has the formal empirical composition (C₆H₁₀O₅)ₙ and, considered formally, is a β-1,4-polyacetal of cellobiose, which itself is constructed of two molecules of glucose. Suitable celluloses consist of from about 500 to 5000 glucose units and, accordingly, have average molecular masses of from 50,000 to 500,000. Cellulose-based disintegrants which can be used also include, in the context of the present invention, cellulose derivatives obtainable by polymer-analogous reactions from cellulose. Such chemically modified celluloses include, for example, products of esterifications and etherifications in which hydroxy hydrogen atoms have been substituted. However, celluloses in which the hydroxyl groups have been replaced by functional groups not attached by an oxygen atom may also be used as cellulose derivatives. The group of the cellulose derivatives embraces, for example, alkali metal celluloses, carboxymethyl-cellulose (CMC), cellulose esters and cellulose ethers and aminocelluloses. Said cellulose derivatives are preferably not used alone as cellulose-based disintegrants but instead are used in a mixture with cellulose. The cellulose derivative content of these mixtures is preferably less than 50% by weight, with particular preference less than 20% by weight, based on the cellulose-based disintegrant. The particularly preferred cellulose-based disintegrant used is pure cellulose, free from cellulose derivatives.

The cellulose used as disintegration aid is preferably not used in finely divided form but instead is converted into a coarser form, for example, by granulation or compaction, before being admixed to the premixes intended for compression. Laundry detergent and cleaning product tablets comprising disintegrants in granular or optionally cogranulated form are described in German Patent Applications DE 197 09 991 (Stefan Herzog) and DE 197 10 254 (Henkel) and in International Patent Application WO98/40463 (Henkel). These documents also provide further details on the production of granulated, compacted or cogranulated cellulose disintegrants. The particle sizes of such disintegrants are usually above 200 μm, preferably between 300 and 1600 μm to the extent of at least 90%, and in particular between 400 and 1200 μm to the extent of at least 90%. The abovementioned, relatively coarse cellulose-based disintegration aids, and those described in more detail in the cited documents, are preferred for use as cellulose-based disintegration aids in the context of the present invention and are available commercially, for example, under the designation Arbocel® TF-30-HG from the company Rettenmaier.

As a further cellulose-based disintegrant or as a constituent of this component it is possible to use microcrystalline cellulose. This microcrystalline cellulose is obtained by partial hydrolysis of celluloses under conditions which attack only the amorphous regions (approximately 30% of the total cellulose mass) of the celluloses and break them up completely but leave the crystalline regions (approximately 70%) intact. Subsequent deaggregation of the microfine celluloses resulting from the hydrolysis yields the microcrystalline celluloses, which have primary particle sizes of approximately 5 μm and can be compacted, for example, to granules having an average particle size of 200 μm.

Laundry detergent and cleaning product tablets which are preferred in the context of the present invention further comprise a disintegration aid, preferably a cellulose-based disintegration aid, preferably in granular, cogranulated or compacted form, in amounts of from 0.5 to 10% by weight, preferably from 3 to 7% by weight, and in particular from 4 to 6% by weight, based in each case on the tablet weight, with preferred disintegration aids having average particle sizes of more than 300 μm, preferably more than 400 μm, and in particular more than 500 μm.

In addition to the abovementioned constituents, builder, surfactant and disintegration aid, the laundry detergent and cleaning product tablets of the invention may further comprise further customary laundry detergent and cleaning product ingredients from the group consisting of bleaches, bleach activators, dyes, fragrances, optical brighteners, enzymes, foam inhibitors, silicone oils, antiredeposition agents, graying inhibitors, color transfer inhibitors, and corrosion inhibitors.

In order to develop the desired bleaching performance, the laundry detergent and cleaning product tablets of the present invention may comprise bleaches. In this context, the customary bleaches from the group consisting of sodium perborate monohydrate, sodium perborate tetrahydrate, and sodium percarbonate have proven particularly appropriate, the latter being markedly preferred.

“Sodium percarbonate” is a term used unspecifically for sodium carbonate peroxohydrates, which strictly speaking are not “percarbonates” (i.e., salts of percarbonic acid) but rather hydrogen peroxide adducts onto sodium carbonate. The commercial product has the average composition 2 Na₂CO₃·3 H₂O₂ and is thus not a peroxycarbonate. Sodium percarbonate forms a white, water soluble powder of density 2.14 g cm⁻³ which breaks down readily into sodium carbonate and oxygen having a bleaching or oxidizing action.

Sodium carbonate peroxohydrate was first obtained in 1899 by precipitation with ethanol from a solution of sodium carbonate in hydrogen peroxide, but was mistakenly regarded as a peroxycarbonate. Only in 1909 was the compound recognized as the hydrogen peroxide addition compound; nevertheless, the historical name (sodium percarbonate) has persisted in the art.

Industrially, sodium percarbonate is produced predominantly by precipitation from aqueous solution (known as the wet process) . In this process, aqueous solutions of sodium carbonate and hydrogen peroxide are combined and the sodium percarbonate is precipitated by means of salting agents (predominantly sodium chloride), crystallizing aids (for example polyphosphates, polyacrylates), and stabilizers (for example, Mg²⁺ ions). The precipitated salt, which still contains from 5 to 12% by weight of the mother liquor, is subsequently centrifuged and dried in fluidized-bed driers at 90° C. The bulk density of the finished product may vary between 800 and 1200 g/l according to the production process. Generally, the percarbonate is stabilized by an additional coating. Coating processes, and substances used for the coating, are amply described in the patent literature. Fundamentally, it is possible in accordance with the invention to use all commercially customary percarbonate types, as supplied, for example, by the companies Solvay Interox, Degussa, Kemira or Akzo.

In the context of the bleaches used, the amount of these substances in the tablets is dependent on the intended use of the tablets. Whereas customary universal laundry detergents in tablet form contain between 5 and 30% by weight, preferably between 7.5 and 25% by weight, and in particular between 12.5 and 22.5% by weight, of bleaches, the amounts in the case of bleach tablets or bleach booster tablets are between 15 and 50% by weight, preferably between 22.5 and 45% by weight, and in particular between 30 and 40% by weight.

In addition to the bleaches used, the laundry detergent and cleaning product tablets of the invention may comprise bleach activator(s), which is preferred in the context of the present invention. Bleach activators are incorporated into laundry detergents and cleaning products in order to achieve an improved bleaching activity when washing at temperatures of 60° C. or below. Bleach activators which may be used are compounds which under perhydrolysis conditions give rise to aliphatic peroxo carboxylic acids having preferably 1 to 10 carbon atoms, in particular 2 to 4 carbon atoms, and/or substituted or unsubstituted perbenzoic acid. Suitable substances are those which carry 0-acyl and/or N-acyl groups of the stated number of carbon atoms, and/or substituted or unsubstituted benzoyl groups. Preference is given to polyacylated alkylenediamines, especially tetraacetylethylenediamine (TAED), acylated triazine derivatives, especially 1,5-diacetyl-2,4-dioxohexa-hydro-1,3,5-triazine (DADHT), acylated glycolurils, especially tetraacetylglycoluril (TAGU), N-acyl imides, especially N-nonanoylsuccinimide (NOSI), acylated phenolsulfonates, especially n-nonanoyl- or isonon- anoyloxybenzenesulfonate (n- or iso-NOBS), carboxylic anhydrides, especially phthalic anhydride, acylated polyhydric alcohols, especially triacetin, ethylene glycol diacetate, and 2,5-diacetoxy-2,5-dihydrofuran.

In addition to the conventional bleach activators, or instead of them, it is also possible to incorporate what are known as bleaching catalysts into the tablets.

These substances are bleach-boosting transition metal salts or transition metal complexes such as, for example, Mn-, Fe-, Co-, Ru- or Mo-salen complexes or -carbonyl complexes. Other bleaching catalysts which can be used include Mn, Fe, Co, Ru, Mo, Ti, V and Cu complexes with N-containing tripod ligands, and also Co-, Fe-, Cu- and Ru-ammine complexes.

If the tablets of the invention comprise bleach activators, they contain, in each case based on the total tablet, between 0.5 and 30% by weight, preferably between 1 and 20% by weight, and in particular between 2 and 15%, of one or more bleach activators or bleaching catalysts. Depending on the intended use of the tablets produced, these amounts may vary. Thus in typical universal laundry detergent tablets, bleach activator contents of between 0.5 and 10% by weight, preferably between 2 and 8% by weight, and in particular between 4 and 6% by weight, are customary, whereas bleach tablets may have consistently higher contents, for example, between 5 and 30% by weight, preferably between 7.5 and 25% by weight, and in particular between 10 and 20% by weight. The skilled worker is not restricted in his or her freedom to formulate and may in this way produce more strongly or more weakly bleaching laundry detergent, cleaning product or bleach tablets by varying the amounts of bleach activator and bleach.

One particularly preferred bleach activator used is N,N,N′,N′-tetraacetylethylenediamine, which is widely used in laundry detergents and cleaning products. Accordingly, in preferred laundry detergent and cleaning product tablets, tetraacetylethylenediamine in the abovementioned amounts is used as bleach activator.

In addition to the abovementioned constituents, bleach, bleach activator, builder, surfactant, and disintegration aid, the laundry detergent and cleaning product tablets of the invention may comprise further customary laundry detergent and cleaning product ingredients from the group consisting of dyes, fragrances, optical brighteners, enzymes, foam inhibitors, silicone oils, antiredeposition agents, graying inhibitors, color transfer inhibitors, and corrosion inhibitors.

In order to enhance the esthetic appeal of the laundry detergent and cleaning product tablets of the invention, they may be colored with appropriate dyes. Preferred dyes, whose selection presents no difficulty whatsoever to the skilled worker, possess a high level of storage stability and insensitivity to the other ingredients of the compositions and to light and possess no pronounced affinity for textile fibers, so as not to stain them.

Preference for use in the laundry detergent and cleaning product tablets of the invention is given to all colorants which can be oxidatively destroyed in the wash process, and to mixtures thereof with suitable blue dyes, known as bluing agents. It has proven advantageous to use colorants which are soluble in water or at room temperature in liquid organic substances. Examples of suitable colorants are anionic colorants, e.g., anionic nitroso dyes. One possible colorant is, for example, naphthol green (Colour Index (CI) Part 1: Acid Green 1; Part 2: 10020) which as a commercial product is obtainable, for example, as Basacid® Green 970 from BASF, Ludwigshafen, and also mixtures thereof with suitable blue dyes. Further suitable colorants include Pigmosol® Blue 6900 (CI 74160), Pigmosol® Green 8730 (CI 74260), Basonyl® Red 545 FL (CI 45170), Sandolan® Rhodamin EB400 (CI 45100), Basacid® Yellow 094 (CI 47005), Sicovit® Patent Blue 85 E 131 (CI 42051), Acid Blue 183 (CAS 12217-22-0, CI Acid Blue 183), Pigment Blue 15 (CI 74160), Supranol® Blue GLW (CAS 12219-32-8, CI Acid Blue 221), Nylosan® Yellow N-7GL SGR (CAS 61814-57-1, CI Acid Yellow 218) and/or Sandolan® Blue (CI Acid Blue 182, CAS 12219-26-0).

In the context of the choice of colorant it must be ensured that the colorants do not have too great an affinity for the textile surfaces, and especially for synthetic fibers. At the same time, it should also be borne in mind in choosing appropriate colorants that colorants possess different stabilities with respect to oxidation. The general rule is that water-insoluble colorants are more stable to oxidation than water-soluble colorants. Depending on the solubility and hence also on the oxidation sensitivity, the concentration of the colorant in the laundry detergents and cleaning products varies. With readily water-soluble colorants, e.g., the abovementioned Basacid® Green, or the likewise abovementioned Sandolan® Blue, colorant concentrations chosen are typically in the range from a few 10⁻² to 10⁻³% by weight. In the case of. the pigment dyes, which are particularly preferred for reason of their brightness but are less readily soluble in water, examples being the abovementioned Pigmosol® dyes, the appropriate concentration of the colorant in laundry detergents or cleaning products, in contrast, is typically from a few 10⁻³ to 10⁻⁴% by weight.

The colorants may comprise optical brighteners of the type of the derivatives of diaminostilbenedisulfonic acid and the alkali metal salts thereof. Examples of suitable brighteners are salts of 4,4′-bis(2-anilino-4-morpholino-1,3,5-triazinyl-6-amino)stilbene-2,2′-disulfonic acid or compounds of similar structure which instead of the morphilino group carry a diethanolamino group, a methylamino group, an anilino group, or a 2-methoxyethylamino group. Furthermore, brighteners of the substituted diphenylstyryl type may be present, examples being the alkali metal salts of 4,4′-bis(2-sulfostyryl)biphenyl, 4,4′-bis(4-chloro-3-sulfostyryl)-biphenyl, or 4-(4-chlorostyryl)-4′-(2-sulfostyryl)-biphenyl. Mixtures of the abovementioned brighteners may also be used. In the laundry detergent and cleaning product tablets of the invention, the optical brighteners are used in concentrations of between 0.01 and 1% by weight, preferably between 0.05 and 0.5% by weight, and in particular between 0.1 and 0.25% by weight, based in each case on the total tablet.

Fragrances are added to the compositions of the invention in order to enhance the esthetic appeal of the products and to provide the consumer with not only product performance but also a visually and sensorially “typical and unmistakeable” product. As perfume oils and/or fragrances it is possible to use individual odorant compounds, examples being the synthetic products of the ester, ether, aldehyde, ketone, alcohol, and hydrocarbon types. Odorant compounds of the ester type are, for example, benzyl acetate, phenoxyethyl isobutyrate, p-tert-butylcyclohexyl acetate, linalyl acetate, dimethylbenzylcarbinyl acetate, phenylethyl acetate, linalyl benzoate, benzyl formate, ethyl methylphenylglycinate, allyl cyclohexylpropionate, styrallyl propionate, and benzyl salicylate. The ethers include, for example, benzyl ethyl ether; the aldehydes include, for example, the linear alkanals having 8-18 carbon atoms, citral, citronellal, citronellyloxyacetaldehyde, cyclamen aldehyde, hydroxycitronellal, lilial and bourgeonal; the ketones include, for example, the ionones, α-isomethylionone and methyl cedryl ketone; the alcohols include anethole, citronellol, eugenol, geraniol, linalool, phenylethyl alcohol, and terpineol; the hydrocarbons include primarily the terpenes such as limonene and pinene. Preference, however, is given to the use of mixtures of different odorants, which together produce an appealing fragrance note. Such perfume oils may also contain natural odorant mixtures, as obtainable from plant sources, examples being pine oil, citrus oil, jasmine oil, patchouli oil, rose oil or ylang-ylang oil. Likewise suitable are muscated, sage oil, camomile oil, clove oil, balm oil, mint oil, cinnamon leaf oil, lime blossom oil, juniperberry oil, vetiver oil, olibanum oil, galbanum oil and labdanum oil, and also orange blossom oil, neroli oil, orange peel oil, and sandalwood oil.

The fragrance content of the laundry detergent and cleaning product tablets prepared in accordance with the invention is usually up to 2% by weight of the overall formulation. The fragrances may be incorporated directly into the compositions of the invention; alternatively, it may be advantageous to apply the fragrances to carriers which intensify the adhesion of the perfume on the laundry and, by means of slower fragrance release, ensure long-lasting fragrance of the textiles. Materials which have become established as such carriers are, for example, cyclodextrins, it being possible in addition for the cyclodextrin-perfume complexes to be additionally coated with further auxiliaries.

Suitable enzymes include in particular those from the classes of the hydrolases such as the proteases, esterases, lipases or lipolytic enzymes, amylases, cellulases or other glycosyl hydrolases, and mixtures of said enzymes. In the laundry, all of these hydrolases contribute to removing stains, such as proteinaceous, fatty or starchy marks and graying. Cellulases and other glycosyl hydrolases may, furthermore, contribute, by removing pilling and microfibrils, to the retention of color and to an increase in the softness of the textile. For bleaching, and/or for inhibiting color transfer it is also possible to use oxidoreductases. Especially suitable enzymatic active substances are those obtained from bacterial strains or fungi such as Bacillus subtilis, Bacillus licheniformis, Streptomyces griseus, Coprinus cinereus and Humicola insolens, and also from genetically modified variants thereof. Preference is given to the use of proteases of the subtilisin type, and especially to proteases obtained from Bacillus lentus. Of particular interest in this context are enzyme mixtures, examples being those of protease and amylase or protease and lipase or lipolytic enzymes, or protease and cellulase or of cellulase and lipase or lipolytic enzymes or of protease, amylase and lipase or lipolytic enzymes, or protease, lipase or lipolytic enzymes and cellulase, but especially protease and/or lipase-containing mixtures or mixtures with lipolytic enzymes. Examples of such lipolytic enzymes are the known cutinases. Peroxidases or oxidases have also proven suitable in some cases. The suitable amylases include, in particular, alpha-amylases, iso-amylases, pullulanases, and pectinases. Cellulases used are preferably cellobiohydrolases, endoglucanases and endoglucosidases, which are also called cellobiases, and mixtures thereof. Because different types of cellulase differ in their CMCase and Avicelase activities, specific mixtures of the cellulases may be used to establish the desired activities.

The enzymes may be adsorbed on carrier substances or embedded in coating substances in order to protect them against premature decomposition. The proportion of the enzymes, enzyme mixtures or enzyme granules may be, for example, from about 0.1 to 5% by weight, preferably from 0.5 to about 4.5% by weight.

In addition, the laundry detergent and cleaning product tablets may also comprise components which have a positive influence on the ease with which oil and grease are washed off from textiles (these components being known as soil repellents). This effect becomes particularly marked when a textile is soiled that has already been laundered previously a number of times with a detergent of the invention comprising this oil- and fat-dissolving component. The preferred oil- and fat-dissolving components include, for example, nonionic cellulose ethers such as methylcellulose and methylhydroxypropylcellulose having a methoxy group content of from 15 to 30% by weight and a hydroxypropoxyl group content of from 1 to 15% by weight, based in each case on the nonionic cellulose ether, and also the prior art polymers of phthalic acid and/or terephthalic acid, and/or derivatives thereof, especially polymers of ethylene terephthalates and/or polyethylene glycol terephthalates or anionically and/or nonionically modified derivatives thereof. Of these, particular preference is given to the sulfonated derivatives of phthalic acid polymers and of terephthalic acid polymers.

The tablets of the invention are produced in two steps. In the first step, laundry detergent and cleaning product tablets are produced in a conventional manner by compressing particulate laundry detergent and cleaning product compositions, and in the second step are provided with the coating.

The present invention therefore additionally provides a process for producing coated detergent tablets by conventionally compressing a particulate detergent composition and subsequently immersing the compressed detergent in, or spraying it with, a melt, solution or dispersion of one or more polyurethanes formed from diisocyanates (I) and diols (II)

O═C═N—R¹—N═C═O (I),

H—O—R²—O—H (II),

the diols being selected at least fractionally from polyethylene glycols (II a) and/or polypropylene glycols (II b)

H—(O—CH₂—CH₂)ₙ—OH (II a),

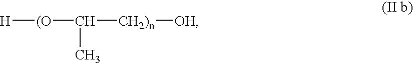

and R¹ and R² independently of one another stand for a substituted or unsubstituted, straight-chain or branched alkyl, aryl or alkylaryl radical having 1 to 24 carbon atoms and n in each case stands for numbers from 5 to 2000.

In analogy to the remarks relating to the laundry detergent and cleaning product tablets of the invention, the abovementioned polymers are also preferred in the case of the process of the invention, so that reference may be made to the above remarks.

There follows a description of the two essential process steps.

The tablets later to be coated in accordance with the invention are produced first of all by dry-mixing the constituents, some or all of which may have been pregranulated, and subsequently shaping the dry mixture, in particular by compression to tablets, in which context it is possible to have recourse to conventional processes. To produce the tablets, the premix is compacted in a so-called die between two punches to form a solid compact. This operation, which is referred to below for short as tableting, is divided into four sections: metering, compaction (elastic deformation), plastic deformation, and ejection.

First of all, the premix is introduced into the die, the fill level and thus the weight and form of the resulting tablet being determined by the position of the lower punch and by the form of the compression tool. Even in the case of high tablet throughputs, constant metering is preferably achieved by volumetric metering of the premix. In the subsequent course of tableting, the upper punch contacts the premix and is lowered further in the direction of the lower punch. In the course of this compaction the particles of the premix are pressed closer to one another, with a continual reduction in the void volume within the filling between the punches. When the upper punch reaches a certain position (and thus when a certain pressure is acting on the premix), plastic deformation begins, in which the particles coalesce and the tablet is formed. Depending on the physical properties of the premix, a portion of the premix particles is also crushed and at even higher pressures there is sintering of the premix. With an increasing compression rate, i.e., high throughputs, the phase of elastic deformation becomes shorter and shorter, with the result that the tablets formed may have larger or smaller voids. In the final step of tableting, the finished tablet is ejected from the die by the lower punch and conveyed away by means of downstream transport means. At this point in time, it is only the weight of the tablet which has been ultimately defined, since the compacts may still change their form and size as a result of physical processes (elastic relaxation, crystallographic effects, cooling, etc).

Tableting takes place in commercially customary tableting presses, which may in principle be equipped with single or double punches. In the latter case, pressure is built up not only using the upper punch; the lower punch as well moves toward the upper punch during the compression operation, while the upper punch presses downward. For small production volumes it is preferred to use eccentric tableting presses, in which the punch or punches is or are attached to an eccentric disk, which in turn is mounted on an axle having a defined speed of rotation. The movement of these compression punches is comparable with the way in which a customary four-stroke engine works. Compression can take place with one upper and one lower punch, or else a plurality of punches may be attached to one eccentric disk, the number of die bores being increased correspondingly. The throughputs of eccentric presses vary, depending on model, from several hundred up to a maximum of 3000 tablets per hour.

For greater throughputs, the apparatus chosen comprises rotary tableting presses, in which a relatively large number of dies is arranged in a circle on a so-called die table. Depending on the model, the number of dies varies between 6 and 55, larger dies also being obtainable commercially. Each die on the die table is allocated an upper punch and a lower punch, it being possible again for the compressive pressure to be built up actively by the upper punch or lower punch only or else by both punches. The die table and the punches move around a common, vertical axis, and during rotation the punches, by means of raillike cam tracks, are brought into the positions for filling, compaction, plastic deformation, and ejection. At those sites where considerable raising or lowering of the punches is necessary (filling, compaction, ejection), these cam tracks are assisted by additional low-pressure sections, low tension rails, and discharge tracks. The die is filled by way of a rigid supply means, known as the filling shoe, which is connected to a stock vessel for the premix. The compressive pressure on the premix can be adjusted individually for upper punch and lower punch by way of the compression paths, the buildup of pressure taking place by the rolling movement of the punch shaft heads past displaceable pressure rolls.

In order to increase the throughput, rotary presses may also be provided with two filling shoes, in which case only one half-circle need be traveled to produce one tablet. For the production of two-layer and multilayer tablets, a plurality of filling shoes are arranged in series, and the gently pressed first layer is not ejected before further filling. By means of an appropriate process regime it is possible in this way to produce laminated tablets and inlay tablets as well, having a construction like that of an onion skin, where in the case of the inlay tablet the top face of the core or of the core layers is not covered and therefore remains visible. Rotary tableting presses can also be equipped with single or multiple tools, so that, for example, an outer circle with 50 bores and an inner circle with 35 bores can be used simultaneously for compresssion. The throughputs of modern rotary tableting presses amount to more than a million tablets per hour.

When tableting with rotary presses it has been found advantageous to perform tableting with minimal fluctuations in tablet weight. Fluctuations in tablet hardness can also be reduced in this way. Slight fluctuations in weight can be achieved as follows:

use of plastic inserts with small thickness tolerances

low rotor speed

large filling shoes

harmonization between the filling shoe wing rotary speed and the speed of the rotor

filling shoe with constant powder level

decoupling of filling shoe and powder charge

To reduce caking on the punches, all of the antiadhesion coatings known from the art are available. Polymer coatings, plastic inserts or plastic punches are particularly advantageous. Rotating punches have also been found advantageous, in which case, where possible, upper punch and lower punch should be of rotatable configuration. In the case of rotating punches, it is generally possible to do without a plastic insert. In this case the punch surfaces should be electropolished.

It has also been found that long compression times are advantageous. These times can be established using pressure rails, a plurality of pressure rolls, or low rotor speeds. Since the fluctuations in tablet hardness are caused by the fluctuations in the compressive forces, systems should be employed which limit the compressive force. In this case it is possible to use elastic punches, pneumatic compensators, or sprung elements in the force path. In addition, the pressure roll may be of sprung design.

Tableting machines suitable in the context of the present invention are obtainable, for example, from the following companies: Apparatebau Holzwarth GbR, Asperg, Wilhelm Fette GmbH, Schwarzenbek, Hofer GmbH, Weil, Horn & Noack Pharmatechnik GmbH, Worms, IMA Verpackungssysteme GmbH, Viersen, KILIAN, Cologne, KOMAGE, Kell am See, KORSCH Pressen AG, Berlin, and Romaco GmbH, Worms. Examples of further suppliers are Dr. Herbert Pete, Vienna (AU), Mapag Maschinenbau AG, Berne (CH), BWI Manesty, Liverpool (GB), I. Holland Ltd., Nottingham (GB), Courtoy N.V., Halle (BE/LU), and Medicopharm, Kamnik (SI). A particularly suitable apparatus is, for example, the hydraulic double-pressure press HPF 630 from LAEIS, D. Tableting tools are obtainable, for example, from the following companies: Adams Tablettierwerkzeuge, Dresden, Wilhelm Fett GmbH, Schwarzenbek, Klaus Hammer, Solingen, Herber & Sohne GmbH, Hamburg, Hofer GmbH, Weil, Horn & Noack, Pharmatechnik GmbH, Worms, Ritter Pharmatechnik GmbH, Hamburg, Romaco GmbH, Worms, and Notter Werkzeugbau, Tamm. Further suppliers are, for example, Senss AG, Reinach (CH) and Medicopharm, Kamnik (SI).

The tablets can be produced in predetermined three-dimensional forms and predetermined sizes. Suitable three-dimensional forms are virtually any practicable designs—i.e., for example, bar, rod or ingot form, cubes, blocks and corresponding three-dimensional elements having planar side faces, and in particular cylindrical designs with a circular or oval cross section. This latter design covers forms ranging from tablets through to compact cylinders having a height-to-diameter ratio of more than 1.

The portioned compacts may in each case be formed as separate, individual elements corresponding to the predetermined dosage of the laundry detergents and/or cleaning products. It is equally possible, however, to design compacts that combine a plurality of such mass units in one compact, with the ease of separation of smaller, portioned units being provided for in particular by means of predetermined breakage points. For the use of textile laundry detergents in machines of the type customary in Europe, with a horizontally arranged mechanism, it may be judicious to design the portioned compacts as tablets, in cylindrical or block form, preference being given to a diameter/height ratio in the range from about 0.5:2 to 2:0.5. Commercial hydraulic, eccentric or rotary presses are suitable in particular for producing such compacts.

The three-dimensional form of another embodiment of the tablets is adapted in its dimensions to the dispener drawer of commercially customary household washing machines, so that the tablets can be metered without a dosing aid directly into the dispenser drawer, where they dissolve during the initial rinse cycle. Alternatively, it is of course readily possible, and preferred in the context of the present invention, to use the laundry detergent tablets by way of a dosing aid.

Another preferred tablet which can be produced has a platelike or barlike structure with, in alternation, long, thick and short, thin segments, so that individual segments can be broken off from this “slab” at the predetermined breaking points, represented by the short, thin segments, and inserted into the machine. This principle of the “slablike” tablet detergent may also be realized in other geometric forms; for example, vertical triangles connected to one another lengthwise at only one of their sides.

However, it is also possible for the various components not to be compressed to a homogeneous tablet, but instead to obtain tablets having a plurality of layers, i.e., at least two layers. In this case it is also possible for these different layers to have different dissolution rates. This may result in advantageous performance properties for the tablets. If, for example, there are components present in the tablets which have adverse effects on each other, then it is possible to integrate one component into the quicker-dissolving layer and the other component into a slower-dissolving layer, so that the first component has already reacted when the second passes into solution. The layer structure of the tablets may be realized in stack form, in which case dissolution of the inner layer(s) at the edges of the tablet takes place at a point when the outer layers have not yet fully dissolved; alternatively, the inner layer(s) may also be completely enveloped by the respective outerlying layer(s), which prevents premature dissolution of constituents of the inner layer(s).

In one further-preferred embodiment of the invention, a tablet consists of at least three layers, i.e., two outer and at least one inner layer, with at least one of the inner layers comprising a peroxy bleach, while in the stack-form tablet the two outer layers, and in the case of the envelope-form tablet the outermost layers, are free from peroxy bleach. Furthermore, it is also possible to provide spatial separation of peroxy bleach and any bleach activators and/or enzymes present in a tablet. Multilayer tablets of this kind have the advantage that they can be used not only by way of a dispenser drawer or by way of a dosing device which is placed into the washing liquor; instead, in such cases it is also possible to place the tablet into the machine in direct contact with the textiles without fear of spotting by bleaches and the like.

In addition to the layer structure, multiphase tablets may also be produced in the form of ring/core tablets, inlay tablets, or what are known as bulleye tablets. An overview of such embodiments of multiphase tablets is described in EP 055 100 (Jeyes Group). That document discloses toilet cleaning blocks comprising a formed body comprising a slow-dissolving cleaning product composition, into which a bleach tablet has been embedded. The document at the same time discloses a wide variety of design forms of multiphase tablets, ranging from the simple multiphase tablet through to complex multilayer systems with inlays.

After compression, the laundry detergent and cleaning product tablets possess high stability. The fracture strength of cylindrical tablets can be gaged by way of the parameter of diametral fracture stress. This diametral fracture stress can be determined by

$$σ = \frac{2 P}{π D t}$$

where □ represents the diametral fracture stress (DFS) in Pa, P is the force in N which leads to the pressure exerted on the tablet that causes it to fracture, D is the tablet diameter in meters, and t is the tablet height.

Preferred production processes for laundry detergent tablets start from granules comprising surfactant which are processed with further processing components to form a particulate premix for compression. Entirely in analogy to the above remarks concerning preferred ingredients of the laundry detergent and cleaning product tablets of the invention, the use of further ingredients is also to be transferred to their preparation. In preferred processes, the particulate premix further comprises one or more types of granules comprising surfactant and has a bulk density of at least 500 g/l, preferably at least 600 g/l, and in particular at least 700 g/l.

In preferred processes of the invention, the granules comprising surfactant have particle sizes of between 100 and 2000 μm, preferably between 200 and 1800 μm, with particular preference between 400 and 1600 μm, and in particular between 600 and 1400 μm.

The further ingredients of the laundry detergent and cleaning product tablets of the invention as well may be introduced into the process of the invention, reference being made to the above remarks. Preferred processes are those wherein the particulate premix further comprises one or more substances from the group consisting of bleaches, bleach activators, disintegration aids, enzymes, pH modifiers, fragrances, perfume carriers, fluorescers, dyes, foam inhibitors, silicone oils, antiredeposition agents, optical brighteners, graying inhibitors, color transfer inhibitors, and corrosion inhibitors.

The second step of the process of the invention comprises applying the coating. For this purpose it is possible to have recourse to common methods of coating bodies, i.e., in particular, the immersion of the body in, or the spraying of the body with, a melt, solution or dispersion of the aforementioned polyurethane.

Since the immersion of detergent tablets in melts or solutions, or dispersions, leads to the desired thin coatings only with a high level of technical expenditure, it is preferred in the context of the present invention to apply polymer solutions or dispersions to the tablets by spraying, the solvent or dispersion medium evaporating to leave a coating on the tablet. In preferred processes of the invention, an aqueous solution of one or more polyurethanes is sprayed onto the tablets, said aqueous solution containing, based in each case on the solution, from 1 to 20% by weight, preferably from 2 to 15% by weight, and in particular from 4 to 10% by weight, of polyurethanes, optionally up to 20% by weight, preferably up to 10% by weight, and in particular less than 5% by weight, of one or more water-miscible solvents, and water as the remainder.

In order to shorten the drying time, further water-miscible solvents of high volatility may be admixed to the aqueous solution. These solvents hail in particular from the group of the alcohols, preference being given to ethanol, n-propanol, and isopropanol. For reasons of cost, ethanol and isopropanol are particularly recommended.

The spray application of such aqueous solutions and dispersions may take place in different ways, which are familiar to the skilled worker. For example, the solution or dispersion may be supplied by means of a pump system to a nozzle, where the solution or dispersion is finely atomized by the high shear forces. The resulting spray mist can then be directed onto the tablets to be coated, which thereafter are optionally dried with the aid of appropriate measures (for example, blowing with heated air). An alternative option is to use a multi-substance nozzle and to form mists of the aqueous solutions or dispersions by means of the nozzle with the aid of a stream of gas. In the simplest case, a dual-substance nozzle is used and compressed air is utilized as the carrier gas. In order to protect the dispersion, if appropriate, against oxidation or other interactions with the carrier gas, it is also possible to use other carrier gases such as nitrogen, noble gases, lower alkanes or ethers, for example.

It is likewise possible to reduce the water content of the dispersion or solution, thereby shortening the drying times, minimizing interactions with moisture-sensitive ingredients on the tablet surface, and lowering the production costs. Here again, appropriate solvents are the abovementioned lower alcohols, less preference being given to completely anhydrous solvent mixtures on account of the fact that certain amounts of water favor the formation of a uniform coat. In preferred processes of the invention, a solution or dispersion of one or more polyurethanes in a solvent or solvent mixture from the group consisting of water, ethanol, propanol, isopropanol, n-heptane and mixtures thereof is sprayed onto the tablets with the aid of inert propellants from the group consisting of nitrogen, dinitrogen oxide, propane, butane, dimethyl ether, and mixtures thereof.

In the case of those process variants which are preferred in accordance with the invention, the composition of the solutions or dispersions is advantageously as follows, the amounts being based in each case on the dispersion that is to be applied by spraying:

i) from 30 to 99% by weight, in particular from 40 to 90% by weight, and in particular from 50 to 85% by weight, of ethanol, propanol, isopropanol, n-heptane or mixtures thereof,

ii) from 0 to 20, preferably from 1 to 15, and in particular from 2 to 10% by weight of water,

iii) from 1 to 50, preferably from 2 to 25, and in particular from 3 to 10% by weight of one or more polyurethanes.

Examples of other possible ingredients of the dispersions to be sprayed include dyes, fragrances, and pigments. Such additives enhance, for example, the visual or olfactory impression of the tablets coated in accordance with the invention. Dyes and fragrances have been described at length above. Examples of suitable pigments are white pigments such as titanium dioxide or zinc sulfide, pearlescent pigments, or color pigments, the latter being subdivisible into inorganic pigments and organic pigments. All said pigments, if used, are used preferably in finely divided form, i.e., with average particle sizes of 100 μm and well below.

In order to achieve the formation of a uniform and very thin coating, it is preferred to produce from the solution or dispersion of the coating materials a very fine mist before applying it to the tablet. Processes of the invention wherein the solution and/or dispersion in question is applied to the tablets by way of a nozzle, the average droplet size in the spray mist being less than 100 μm, preferably less than 50 μm, and in particular less than 35 μm, are preferred. In this way, the abovementioned preferred thickness of the coating is easy to realize.

Since the polymers used as the coating in accordance with the invention can be melted without undergoing decomposition it is possible, advantageously, to forego the use of solutions or dispersions and instead to apply a melt of the coating to the tablets. Processes of the invention wherein a melt comprising one or more polyurethanes with or without further constituents is applied to the tablets are therefore preferred in accordance with the invention.

The present invention additionally provides for the use of polymers or polymer mixtures for coating detergent tablets, the polymer, or at least 50% by weight of the polymer mixture, being selected from the group consisting of polyurethanes formed from diisocyanates (I) and diols (II)

O═C═N—R¹—N═C═O (I),

H—O—R²—O—H (II),

the diols being selected at least fractionally from polyethylene glycols (II a) and/or polypropylene glycols (II b)

H—(O—CH₂—CH₂)ₙ—OH (II a),

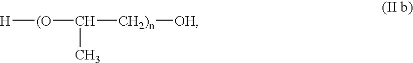

and R¹ and R² independently of one another standing for a substituted or unsubstituted, straight-chain or branched alkyl, aryl or alkylaryl radical having 1 to 24 carbon atoms, and n in each case standing for numbers from 5 to 2000.

As regards preferred embodiments of the use in accordance with the invention (ingredients, premix composition, preferred polymers, etc.), the comments made above for the process of the invention apply analogously.

What is claimed is:

1. A tablet of compacted particulate detergent, comprising builder(s) and, if desired, further detergent ingredients, wherein the tablet is provided with a coating which comprises polyurethanes formed from diisocyanates (I) and diols (II)
O═C═N—R¹—N═C═O (I),
H—O—R¹—O—H (II),
the diols being selected at least fractionally from polyethylene glycols (II a) and/or polypropylene glycols (II b)
H—(O—CH₂—CH₂)ₙ—OH (II a), 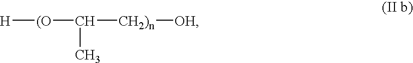
and R¹ and R² independently of one another stand for a substituted or unsubstituted, straight-chain or branched alkyl, aryl or alkylaryl radical having 1 to 24 carbon atoms and n stands in each case for numbers from 5 to 2000.

2. The tablet as claimed in claim 1, which is provided with a coating in which at least 10% by weight, preferably at least 25% by weight, more preferably at least 50% by weight, and in particular at least 75% by weight of the diols incorporated into the polyurethane by reaction are selected from polyethylene glycols (II a) and/or polypropylene glycols (II b).

3. The tablet as claimed in either of claims 1 and 2, wherein the coating contains at least 10% by weight, preferably at least 25% by weight, more preferably at least 50% by weight, and in particular at least 75% by weight of polyurethanes.

4. The tablet as claimed in claim 3, wherein the coating consists entirely of polyurethane.

5. The tablet as claimed in any of claims 1 to 4, wherein the coating comprises polyurethanes formed from diisocyanates (I) and diols (II)
O═C═N—R¹—N═C═O (I),
H—O—R²—O—H (II),
where R¹ stands for a methylene, ethylene, propylene, butylene or pentylene group or for —(CH₂)₆— or for 2,4- or 2,6-C₆H₃—CH₃, or for C₆H₄—CH₂—C₆H₄ or for an isophorone radical (3,5,5-trimethyl-2-cyclohexenone) and R² is selected from —CH₂—CH₂—(O—CH₂—CH₂)ₙ— or —CH₂—CH₂—(O—CH(CH₃)—CH₂)ₙ— with n=4 to 1999.

6. The tablet as claimed in any of claims 1 to 5, wherein the polyurethanes in the coating contain structural units of the formula (III)
—[O—C(O)—NH—R¹—NH—C(O)—O—R²]ₖ— (III),
in which R¹ stands for -(CH₂)₆- or for 2,4- or 2,6-C₆H₃—CH₃, or for C₆H₄—CH₂—C₆H₄, and R² is selected from —CH₂—CH₂—(O—CH₂—CH₂)ₙ— or —CH(CH₃)—CH₂—(O—CH(CH₃)—CH₂)ₙ—, where n is a number from 5 to 199 and k is a number from 1 to 2000.

7. The tablet as claimed in any of claims 1 to 6, wherein the poplyurethanes in the coating comprise additional diamines, preferably hexamethylenediamine, and/or hydroxycarboxylic acids, preferably dimethylolpropionic acid.

8. The tablet as claimed in any of claims 1 to 7, wherein the polyurethanes in the coating have molar masses of from 5000 to 150,000 g mol⁻¹, preferably from 10,000 to 100,000 g mol⁻¹, and in particular from 20,000 to 50,000 g mol⁻¹.

9. The tablet as claimed in any of claims 1 to 8, wherein the weight ratio of uncoated tablet to coating is greater than 10:1, preferably greater than 25:1, and in particular greater than 50:1.

10. The tablet as claimed in any of claims 1 to 9, wherein the thickness of the coating on the tablet is from 0.1 to 500 μm, preferably from 0.5 to 250 μm, and in particular from 5 to 100 μm.

11. The tablet as claimed in any of claims 1 to 3 and 5 to 10, wherein the coating further comprises one or more substances from the groups of the disintegration aids, dyes, optical brighteners, fragrances, enzymes, bleaches, bleach activators, silver protectants, complexing agents, surfactants, graying inhibitors, and mixtures thereof in amounts of from 0.5 to 30% by weight, preferably from 1 to 20% by weight, and in particular from 2.5 to 10% by weight, based in each case on the weight of the coating.

12. A process for producing coated detergent tablets by conventionally compressing a particulate detergent composition and subsequently immersing the compressed detergent in, or spraying it with, a melt, solution or dispersion of one or more polyurethanes formed from diisocyanates (I) and diols (II)
O═C═N—R¹—N═C═O (I),
H—O—R²—O—H (II),
the diols being selected at least fractionally from polyethylene glycols (II a) and/or polypropylene glycols (II b)
H—(O—CH₂—CH₂)ₙ—OH (II a), 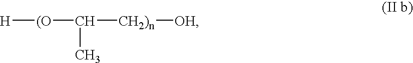
and R¹ and R² independently of one another stand for a substituted or unsubstituted, straight-chain or branched alkyl, aryl or alkylaryl radical having 1 to 24 carbon atoms and n in each case stands for numbers from 5 to 2000.

13. The process as claimed in claim 12, wherein an aqueous solution of one or more polyurethanes is applied to the tablet by spraying, the aqueous solution containing, based in each case on the solution, from 1 to 20% by weight, preferably from 2 to 15% by weight, and in particular from 4 to 10% by weight of polyurethane(s), optionally up to 20% by weight, preferably up to 10% by weight, and in particular less than 5% by weight, of one or more water-miscible solvents, and water as the remainder.

14. The process as claimed in claim 13, wherein a solution or dispersion of one or more polyurethanes in a solvent or solvent mixture selected from the group consisting of water, ethanol, propanol, isopropanol, n-heptane, and mixtures thereof is sprayed onto the tablets with the aid of inert propellants from the group consisting of nitrogen, dinitrogen oxide, propane, butane, dimethyl ether, and mixtures thereof.

15. The process as claimed in claim 14, wherein the composition of the solution or dispersion is as follows:
iv) from 30 to 99% by weight, in particular from 40 to 90% by weight, and in particular from 50 to 85% by weight, of ethanol, propanol, isopropanol, n-heptane or mixtures thereof,
v) from 0 to 20, preferably from 1 to 15, and in particular from 2 to 10% by weight of water,
vi) from 1 to 50, preferably from 2 to 25, and in particular from 3 to 10% by weight of one or more polyurethanes.

16. The process as claimed in claim 12, wherein a melt comprising one or more polyurethanes with or without further constituents is applied to the tablets.

17. The process as claimed in any of claims 12 to 16, wherein the tablet to be coated is obtained by compressing a particulate premix which comprises one or more surfactant-comprising granules and has a bulk density of at least 500 g/l, preferably at least 600 g/l, and in particular at least 700 g/l.

18. The process as claimed in claim 17, wherein the surfactant-comprising granules have particle sizes of between 100 and 2000 μm, preferably between 200 and 1800 μm, with particular preference between 400 and 1600 μm, and in particular between 600 and 1400 μm.

19. The process as claimed in either of claims 17 and 18, wherein the particulate premix further comprises one or more substances selected from the group consisting of bleaches, bleach activators, disintegration aids, enzymes, pH modifiers, fragrances, perfume carriers, fluorescers, dyes, foam inhibitors, silicone oils, antiredeposition agents, optical brighteners, graying inhibitors, color transfer inhibitors, and corrosion inhibitors.

20. The use of polymers or polymer mixtures for coating detergent tablets, the polymer, or at least 50% by weight of the polymer mixture, being selected from the group consisting of polyurethanes formed from diisocyanates (I) and diols (II)
O═C═N—R¹—N═C═O (I),
H—O—R²—O—H (II),
the diols being selected at least fractionally from polyethylene glycols (II a) and/or polypropylene glycols (II b)
H—(O—CH₂—CH₂)ₙ—OH (II a), 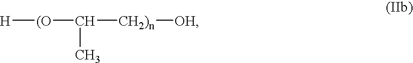
and R¹ and R² independently of one another standing for a substituted or unsubstituted, straight-chain or branched alkyl, aryl or alkylaryl radical
having 1 to 24 carbon atoms, and n in each case standing for numbers from 5 to 2000.
